(19) United States
(12) Patent Application Publication
(10) Pub. No.: US 2025/0045599 A1
(43) Pub. Date: Feb. 6, 2025

(54) METHODS AND SYSTEMS FOR DISTRIBUTED TRAINING A DEEP NEURAL NETWORK

(71) Applicant: Huawei Technologies Co., Ltd., Shenzhen (CN)

(72) Inventors: Adam Christian Cavatassi, Mississauga (CA); Yiqun Ge, Kanata (CA); Wen Tong, Ottawa (CA); Wuxian Shi, Kanata (CA)

(21) Appl. No.: 18/884,948

(22) Filed: Sep. 13, 2024

Related U.S. Application Data
(63) Continuation of application No. PCT/CN2022/081013, filed on Mar. 15, 2022.

(51) Int. Cl. G06N 3/0985

(52) U.S. Cl. CPC G06N 3/0985

(57) ABSTRACT

Some embodiments of the present application provide a forward-propagation-only (FP-only) method of training a DNN model. Such methods result in a trained DNN model whose performance comparable to a DNN model trained using bidirectional training methods. The FP-only method for training a DNN model may operate without employing the known chain rule. The chain rule is employed when computing gradients for a backward propagation in a bidirectional method. The FP-only method may allow for the computations and updates to the parameters for each layer of the DNN model to be performed in parallel. The FP-only methods for training a DNN model use stochastic gradient descent and the FP-only method for training a DNN model still involves computing gradients. However, the FP-only methods of training a DNN model allow for computing of gradients without the chain rule.

### CROSS-REFERENCE TO RELATED APPLICATIONS

This application is a continuation of International Application No. PCT/CN2022/081013, filed on Mar. 15, 2022, which is hereby incorporated by reference in its entirety.

### TECHNICAL FIELD

The present disclosure relates, generally, to training deep neural networks and, in particular embodiments, to methods and system for distributed training of a DNN using only forward propagation.

### BACKGROUND

In the field of artificial intelligence, a deep neural network (DNN) may be understood to employ deep learning when operating as intended. A DNN is understood to include a vast quantity of interconnected neurons. Taking advantage of the benefits of deep learning may be seen to involve implementing two modes. A first mode is concerned with training. A second mode is concerned with inference.

In the first mode, which may also be called a training mode, a DNN receives training data and a specific training goal or target. The training data is used, by the DNN, to adjust coefficients of the neurons of the DNN so that, eventually, the trained DNN fulfills the specific training goal.

In the second mode, which may also be called an inference mode, an input data sample is fed into the trained DNN. Responsive to receiving the input data cycle, the DNN outputs a prediction.

### SUMMARY

Aspects of the present application are designed to support DNN-based applications and DNN-based services in future communications systems. Those future communications systems may be wireless, wired or a mix of wireless and wired. By spreading activities related to the training of a DNN among a local node and various remote nodes and carrying out the training in a forward-propagation-only manner, DNN layers may be effectively and efficiently trained.

It may be understood that training a DNN is significantly more complex than operating the DNN for inference. Training a DNN typically involves backward propagation for updating parameters (e.g. weights and biases) of each layer of the DNN. During training, the goal is to minimize a difference between a DNN output by updating the parameters in each round of training, which is obtained by the DNN based on a training input, and a training output, which is associated with the training input. Approaches to backward propagation are known to use a chain rule when determining gradients that are involved in updating of the parameters of the DNN. It may be considered that use of the chain rule adds complexity and restricts the determining of gradients to occurring sequentially.

Known distributed methods for training a DNN may be perceived to be associated with weak protection of privacy and intellectual property. One example of a distributed method for training a DNN is federated learning. Another example of distributed method for training a DNN involve backpropagation across said wired/wireless connections and involve transmitting gradients for every batch of training data. Known distributed methods for training a DNN may be discounted on the basis of the quantity of traffic involved in the transmission of training data sets. Known distributed methods for training a DNN may further be perceived to be associated with low efficiency when backward propagation is employed during training of the DNN.

Forward-propagation-only (FP-only) methods (single-directional) are disclosed for training a DNN to achieve performance comparable to known methods for training a DNN that employ backward propagation (BP). Such FP-only methods for training a DNN may be shown to operate without use of the chain rule that is used in methods for training a DNN that employ BP during training of the DNN. This lack of use of chain rule allows for each layer of the DNN to be trained in parallel. The FP-only methods for training a DNN use stochastic gradient descent to determine gradients which are used to update the parameters of layers of the DNN. However, FP-only methods for training a DNN allow for determination of a gradient without the chain rule. By maintaining some of the implementation of DNN layers as a local node, protection of privacy and intellectual property is enhanced. By distributing training data in the form of kernel matrices, aspects of the present application may be shown to reduce the quantity of traffic transmitted between edge computing nodes that are involved in the training of a DNN. It may be shown that FP-only methods for training a DNN may be adapted for parallel processing, thereby providing an efficiency boost over methods for training a DNN that employ BP.

According to an aspect of the present disclosure, there is provided a neural network training method for carrying out at a local node, wherein the neural network includes an input layer, at least one intermediate layer and a plurality of output layers, wherein the local node is configured to implement the input layer and the plurality of output layers. The method includes sampling a batch of training data inputs from a plurality of training data inputs and a batch of training data labels from a plurality of training data labels, the plurality of training data labels having a corresponding training data input in the plurality of training data inputs, determining an input kernel matrix based on the sampled training data inputs, determining a label kernel matrix based on the sampled training data labels, transmitting, to a first edge computing node configured to perform computations of one of the intermediate layers, the input kernel matrix and the label kernel matrix, performing computations of the input layer, on the basis of the sampled training data inputs and the sampled training data labels to generate input layer activation data, transmitting, to the first edge computing node, the input layer activation data, receiving, from a last edge computing node configured to perform computations of a last intermediate layer of the at least one intermediate layers, last intermediate layer activation data and implementing the plurality of output layers, on the basis of the last intermediate layer activation data, to generate a predicted label.

According to an aspect of the present disclosure, there is provided a neural network training method for carrying out at a given edge computing node, wherein the neural network includes an input layer, at least one intermediate layer and a plurality of output layers, wherein the edge computing node is configured to implement the at least one intermediate layer. The method includes receiving a training request, where the training request is specific to the given edge computing node and includes an indication of an input node and an output node, receiving an input kernel matrix and an output kernel matrix, receiving, from the input node, input activation data, carrying out a training task on the at least one intermediate layer based on the input kernel matrix, the output kernel matrix and the input activation data, thereby resulting in output activation data and transmitting, to the output node, the output activation data.

According to an aspect of the present disclosure, there is provided a neural network training method for carrying out over a system that includes a local node and an edge computing node, wherein the neural network includes an input layer, at least one intermediate layer and a plurality of output layers, wherein the local node is configured to implement the input layer and the plurality of output layers, wherein the edge computing node is configured to implement the at least one intermediate layer. The method includes, at the local node, sampling a batch of training data inputs from the plurality of training data inputs and a batch of training data labels from a plurality of training data labels, the plurality of training data labels having a corresponding training data input in the plurality of training data inputs, determining an input kernel matrix based on the sampled training data inputs, determining a label kernel matrix based on the sampled training data labels, transmitting, to the edge computing node, the input kernel matrix and the label kernel matrix, performing computations of the input layer, on the basis of the sampled training data inputs and the sampled training data labels to generate input layer activation data, transmitting, to the edge computing node, the input layer activation data, receiving, from a last edge computing node configured to perform computations of a last intermediate layer of the at least one intermediate layers, last intermediate layer activation data and implementing the plurality of output layers, on the basis of the last intermediate layer activations, to generate a predicted label. method includes, at the edge computing node, receiving a training request, where the training request is specific to the edge computing node and includes an indication of the local node as an input node and an indication of an output node, receiving the input kernel matrix and the output kernel matrix, receiving, from the local node, the input layer activation data, carrying out a training task on the at least one intermediate layer based on the input kernel matrix, the output kernel matrix and the input activation data, thereby resulting in output activation data and transmitting, to the output node, the output activation data.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, in a block diagram, a channel representative of a neural network;

FIG. 6 illustrates a manner of determining a Hilbert-Schmidt Independence Criterion (HSIC) distance, in accordance with aspects of the present application;

FIG. 7 illustrates an HSIC-based Information Bottleneck Principle;

FIG. 8 illustrates a representation of two intermediate layers of a DNN;

FIG. 9 illustrates explicit reinforcement of an HSIC-based Information Bottleneck on an intermediate layer function on a batch of training data, in accordance with aspects of the present application;

FIG. 10 illustrates, at a particular training moment, three consecutive layers forming a pipeline, in accordance with aspects of the present application;

FIG. 11 illustrates, in a block diagram, a local node configured to arrange the carrying out of a neural network training method in the context of a computation cloud that includes edge computing nodes, in accordance with aspects of the present application;

FIG. 12 illustrates example steps in a forward-propagation-only method for training a neural network, in accordance with aspects of the present application; and

FIG. 13 illustrates example steps in a method of training carried out at a given edge computing node from FIG. 11, in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

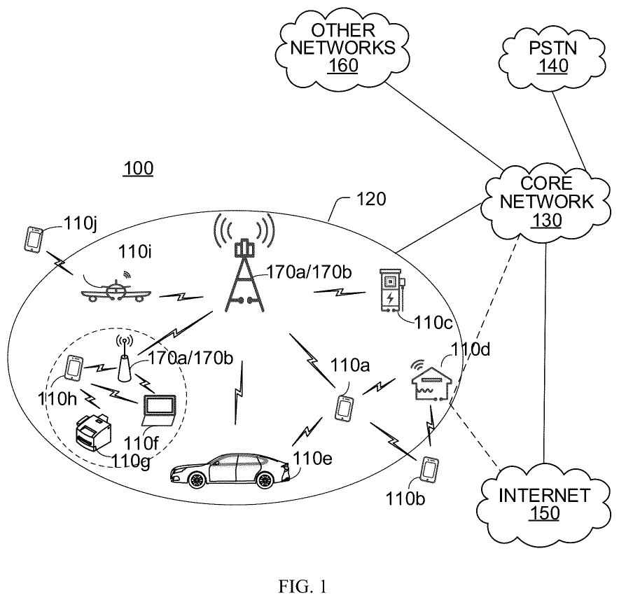

Referring to FIG. 1, as an illustrative example without limitation, a simplified schematic illustration of a communication system is shown. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as ED 110 and collectively referred to as EDs 110) may be interconnected to one another or connected to one or more radio access network (RAN) nodes 170a, 170b generically referred to as RAN node 170 and collectively referred to as RAN nodes 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

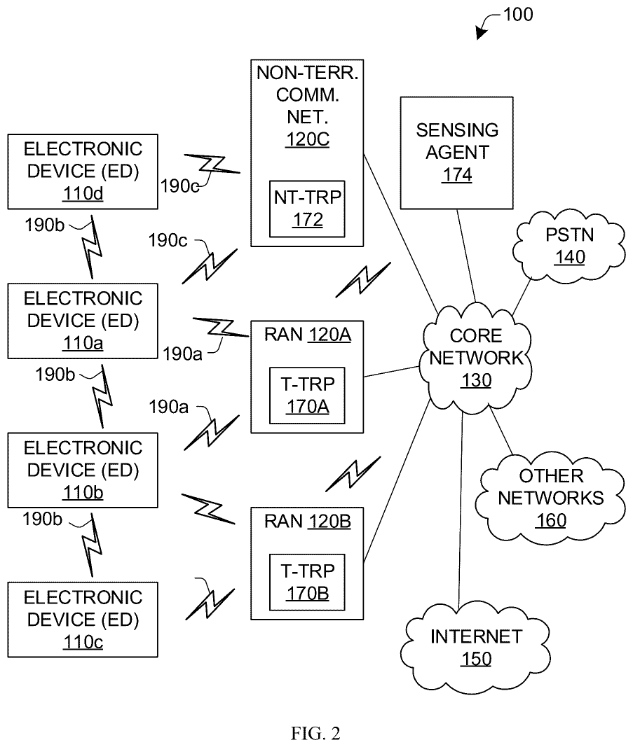

FIG. 2 illustrates examples of various networks and the EDs 110 of the communication system 100 shown in FIG. 1. In general, the communication system 100 enables multiple wireless or wired elements (e.g., EDs 110, RANS 120, core network 130) to communicate data and other content, such as voice, video, and/or text, via broadcast, multicast and unicast, etc. The communication system 100 may operate by sharing resources, such as carrier spectrum bandwidth, between its wireless elements (e.g., RANs 120 and EDs 110) for wireless communications. The communication system 100 may include a terrestrial communication network and/or a non-terrestrial communication network. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication network and a non-terrestrial communication network. For example, integrating a non-terrestrial communication network (or components thereof) into a terrestrial communication network can result in what may be considered a heterogeneous communication network comprising multiple layers. Compared to conventional communication networks, the heterogeneous communication network may achieve better overall performance through efficient multi-link joint operation, more flexible functionality sharing and faster physical layer link switching between terrestrial networks and non-terrestrial networks. The RAN 120 and the core network 130 may be a non-terrestrial communication network, a non-terrestrial communication network, or a heterogeneous communication network.

The terrestrial communication network and the non-terrestrial communication network could be considered sub-network of the communication system. In the example shown in FIG. 2, the communication system 100 includes the ED 110a, 110b, 110c, 110d, RANs 120a, 120b, 120c, the core network 130, the public switched telephone network (PSTN) 140, the Internet 150 and the other networks 160. The RANs 120a, 120b are terrestrial communication networks and the RANs 120a, 120b include RAN nodes 170a, 170b, each of which may be a terrestrial transmit and receive points (T-TRP). The RAN 120c is a non-terrestrial communication network, and includes RAN node 120c, which may be a non-terrestrial transmit and receive point (NT-TRP).

It will be appreciated that any of the EDs 110a, 110b, 110c, 110d may be alternatively or additionally configured to interface, access, or communicate with any RAN node 170a, 170b and 170c. In some examples, the ED 110a may communicate an uplink and/or downlink transmission over a terrestrial air interface 190a with RAN node 170a (e.g., T-TRP). In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172. Notably, any of the RAN nodes 170 may include, or may communicate with, one or more edge computing devices (otherwise referred to as edge computing node) which perform some of the operations of a method for training a DNN of the present disclosure.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple RAN nodes 170c via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

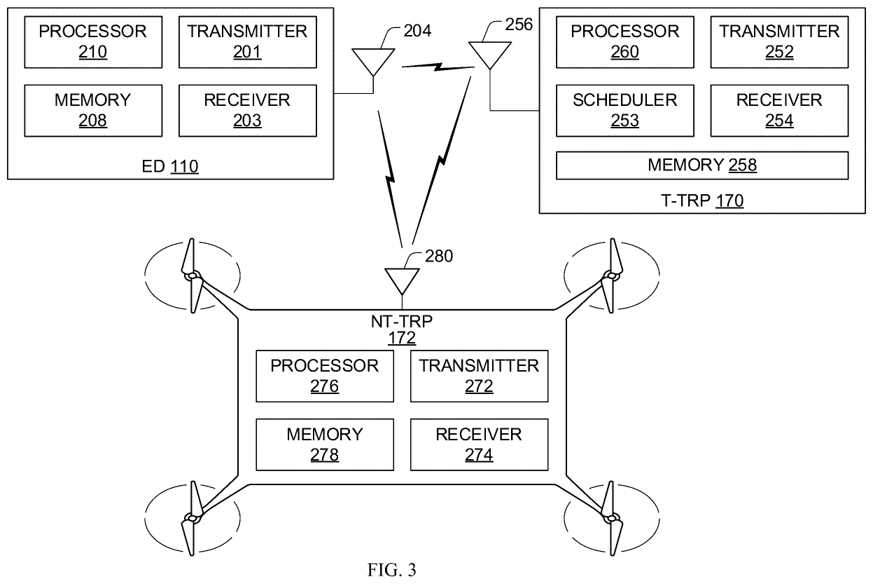

FIG. 3, illustrates block diagrams of an example ED 110, an example RAN node 170a which is a T-TRP and RAN node 170c which is a NT-TRP. Other EDs 110 and RAN nodes 170 of the communication system 100 may be similar to the ED 110 and RAN nodes 170a and 170c shown in FIG. 3. The ED 110 is used by persons, objects, machines, etc. and may connect to a network, such as RAN 120, or to another ED 110. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc. The ED 110 illustrated, in FIG. 3, including the UE processor 210 and the UE memory 208, may be referenced, hereinafter, as a “local node” that performs some of the operations of the method of training a DNN of the present disclosure.

Each ED 110 represents any suitable end user device for wireless operation and may be referred to as a user equipment (UE) or user device. The ED 110 may be any type of end user device, such as a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, an edge computing device, or an apparatus (e.g., communication module, modem, or chip) in the forgoing end user devices, among other possibilities. Future generation EDs 110 may be referred to using other terms. As shown in FIG. 3, ED 110 may be connected to the RAN node 170a and/or RAN node 170c and ED 110 can be dynamically or semi-statically turned-on (i.e., established, activated or enabled), turned-off (i.e., released, deactivated or disabled) and/or configured in response to one of more of: connection availability; and connection necessity.

As shown in FIG. 3, ED 110 includes a transmitter 201 and a receiver 203 coupled to one or more antennas 204. Only one antenna 204 is illustrated in FIG. 3. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless signals.

ED 110 also includes at least one memory 208. The at least one memory 208 stores instructions and data used, generated, or collected by ED 110. For example, the at least one memory 208 could store software instructions or modules configured to implement some or all of the functionality and/or embodiments of the method training a DNN described herein and that are executed by one or more processing unit(s) (e.g., a processor 210). Each memory 208 includes any suitable volatile and/or non-volatile storage, such as random-access memory (RAM), read only memory (ROM), a hard disk, an optical disc, a solid-state drive, subscriber identity module (SIM) card, memory stick, secure digital (SD) memory card, on-processor cache and the like.

ED 110 may further include one or more input/output devices (not shown) or interfaces (such as a wired interface to a wired access point that provides connection to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

ED 110 also includes the processor 210 for performing operations including those operations related to preparing a transmission for uplink transmission to the RAN node 170c and/or RAN nodes 170a, 170b, those operations related to processing downlink transmissions received from the NT-TRP 172 and/or the T-TRP 170, those operations related to processing sidelink transmission to and from another ED 110, and some of the operations related to the method of training a DNN of the present disclosure. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the RAN node 170c and/or by the RAN node 170a. In some embodiments, the processor 210 implements the transmit beamforming and/or the receive beamforming based on the indication of beam direction, e.g., beam angle information (BAI), received from the RAN node. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the RAN node 170c and/or from RAN node 170a.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The RAN node 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, a terrestrial transmit and receive point (T-TRP), a non-terrestrial transmit and receive point (T-TRP), an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The RAN node 170 may be a macro BS, a pico BS, a relay node, a donor node, or the like, or combinations thereof. A RAN node 170 may refer to the forgoing devices or refer to apparatus (e.g., a communication module, a modem or a chip) in the forgoing devices.

In some embodiments, the parts of the RAN node 170 may be distributed. For example, some of the modules of the RAN node 170 may be located remote from the equipment that houses antennas 256 for the RAN node 170, and may be coupled to the equipment that houses antennas 256 over a communication link (not shown) sometimes known as front haul, such as common public radio interface (CPRI). Therefore, in some embodiments, the term RAN node 170 may also refer to modules on the network side that perform processing operations, such as determining the location of the ED 110, resource allocation (scheduling), message generation, and encoding/decoding, and that are not necessarily part of the equipment that houses antennas 256 of the RAN node 170. The modules may also be coupled to other RAN nodes 170. In some embodiments, the RAN node 170 may comprise a plurality of TRPs (e.g., T-TRPs and/or N-TRPs) that are operating together to serve the ED 110, e.g., through the use of coordinated multipoint transmissions. In some embodiments, one or more edge computing devices (otherwise referred to as edge computing nodes) may be located remote from the equipment that houses antennas 256 for the T-TRP 170 and may be coupled to the equipment that houses antennas 256 for the T-TRP 170 over a communication link. The one or more edge computing devices may perform some of the operations related to the method of training a DNN of the present disclosure, such as the operations related to computing intermediate layer activation data for an intermediate layer of the DNN and the operations related to updating parameters of the intermediate layer of the DNN during training of the DNN as described in further detail below.

As illustrated in FIG. 3, the RAN nodes, 170a, 170b include at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. RAN node 170 further includes a processor 260 for performing operations including those related to: preparing a transmission for downlink transmission to the ED 110; processing an uplink transmission received from the ED 110; preparing a transmission for backhaul transmission to another RAN node 170; and processing a transmission received over backhaul from another RAN node 170. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH). In some embodiments, the memory 258 and the processor 260 may perform some of the operations of the method of training a DNN of the present disclosure. In these embodiments, the memory 258 and the processor 260 may be considered to be an “edge computing device” or “edge computing node”.

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the RAN node 170c, which is an NT-TRP, is illustrated as a drone in FIG. 3 only for illustrative purposes, and the RAN node 107c, which is a NT-TRP, may be any suitable non-terrestrial device. An NT-TRP may be known by other names in some implementations, such as a non-terrestrial node, a non-terrestrial network device, or a non-terrestrial base station. RAN node 170c, which is a NT-TRP, includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. RAN node 170c further includes a processor 276 for performing operations including those related to: preparing a transmission for downlink transmission to ED 110; processing an uplink transmission received from ED 110; preparing a transmission for backhaul transmission to RAN node 170, which is a T-TRP; and processing a transmission received over backhaul from RAN node 170a, which is a T-TRP. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from RAN node 170a. In some embodiments, the processor 276 may generate signaling, e.g., to configure one or more parameters of ED 110. In some embodiments, the RAN node 170c implements physical layer processing but does not implement higher layer functions such as functions at the medium access control (MAC) or radio link control (RLC) layer. As this is only an example, more generally, the RAN node 170c may implement higher layer functions in addition to physical layer processing. In some embodiments, one or more edge computing devices (otherwise referred to as edge computing nodes) may be located remote from RAN node 170 and may be coupled to RAN node 170 via a communication link. The one or more edge computing devices may perform some of the operations related to the method of training a DNN of the present disclosure, such as the operations related to computing intermediate layer activation data for an intermediate layer of the DNN and the operations related to updating parameters of the intermediate layer of the DNN during training of the DNN as described in further detail below.

RAN node 170c further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, RAN node 170c may include a plurality of NT-TRPs that are operating together to serve the ED 110, e.g., through coordinated multipoint transmissions. In some embodiments, the processor 276 may perform some of the operations of the method of training a DNN of the present disclosure and the memory 278 may store parameters of the DNN.

RAN node 170a, RAN node 170c, and/or ED 110 may include other components, but these have been omitted for the sake of clarity.

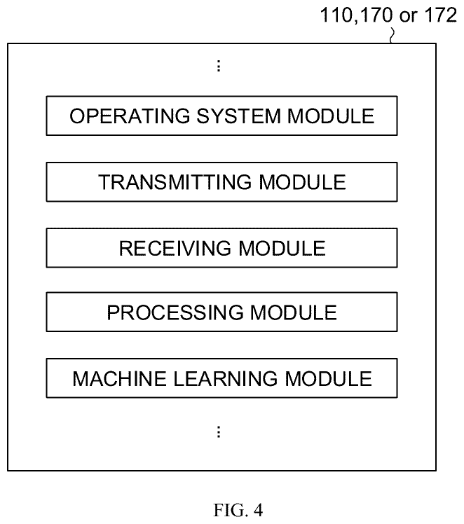

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding EDs 110, and RAN nodes 170 are known to those of skill in the art. As such, these details are omitted here.

To train a DNN (otherwise referred as a model or DNN model) to perform a particular task, such as a computer-vision task on images, a natural language processing task on text, a speech processing task on speech signals, or any other machine learning task, a training data set, one or more training goals and computation resources are required.

The DNN model has an architecture and a set of hyperparameters. Detailed information about a DNN model may, for example, specify a number of layers in the DNN. Detailed information about a DNN model may, for example, specify an activation function computed at the neurons of each layer of the DNN. A layer may, for example, be a convolutional layer, a normalization layer, pooling layer, or a fully connected layer, or any other type of suitable layer.

A training dataset may include input dataset, X, and ground truth dataset, Y. The input dataset X includes multiple input data samples, x, related to the task being performed by the DNN model. For example, if the DNN model performs a computer-vision task, each input data sample is an image or a video. If DNN model performs a natural language processing task, each input data sample may be a one-hot representation of a word from a dictionary comprising K-words. The ground truth dataset Y includes a multiple ground truth data samples (e.g., ground truth labels), with each ground data sample y (e.g., ground truth label) corresponding to one input data sample in the input dataset, X.

The training dataset may be organized into random batches of training data, with each batch of training data containing a number (e.g., m) of input data samples obtained from input dataset, X and corresponding ground truth data sample (e.g., ground truth label) obtained from the ground truth dataset Y of the training dataset. So-called “high quality” input data samples may feature thousands of dimensions. The input dataset, X, may be considered private property and the ground truth dataset, Y, may be considered to be highly valued intellectual property. This value stems from a consideration that expensive procedures, such as labelling of input data samples and cleaning of input data samples, are important to the overall performance a trained DNN model.

A DNN model is trained to fulfill one or more training goals. For one example, a training goal for a DNN model which performs image classification may be established as being related to minimizing cross-entropy loss. For another example, a training goal related for a DNN model which is an autoencoder may be established as being related to minimizing a square error. A training goal may be considered to be user-specific private property. Given the same training dataset, distinct users may train a DNN model which performs a particular task to fulfill distinct training goals. The distinct training goals may be understood to be closely aligned with the commercial interests of the distinct users.

One type of computation resource used by a computing system to train a DNN is a GPU. Perhaps the most common method of training a DNN model involves optimizing parameters of the DNN model by using stochastic gradient descent (SGD) during backpropagation to compute updates for the parameters of the DNN model. In a method of training a DNN model that involves use of SGD to optimize the parameters of the DNN model, gradients are determined for a batch of input data samples x, and corresponding ground truth data sample (e.g., ground truth label) y obtained from a training dataset. The method of training involves performing forward propagation (FP), during which an inference result ŷ is determined based on each input data sample x in a batch of training data. The inference result ŷ may be compared to the corresponding ground truth data sample y included in that corresponds to the input data sample x in the batch of training data, and a loss (otherwise referred to as an error) may be computed based on a loss function. After computing the error (e.g., loss) for the batch of training data, backward propagation (BP) is performed to update the parameters of the DNN model. BP is performed to reduce the error (e.g., loss) between the inference results y generated by the DNN model and the ground truth data sample (e.g., ground truth label) y that correspond to the input data samples x of the batch of training data. Computing the gradients during BP involves using the chain rule. BP involves adjusting (i.e., updating) the parameters (e.g., weights and biases) of the DNN model based on the computed gradients to reduce the error (i.e., loss) between each inference result generated based on an input data sample x and a corresponding ground truth data sample (e.g., ground truth label) y in the batch of training data.

Subsequent FP and BP are performed in an alternating pattern (FP→BP→FP→BP . . . ) for each batch of training data. It may be shown that cost, in terms of computation resources (e.g., memory and processing resources), of computing the gradients during BP is much higher than the cost, in terms of computation resources, of determining the inference result during FP. For very deep DNN models, hundreds or thousands of GPU cores may be employed to perform training of a DNN model in which SGD is used to optimize the parameters of the DNN model.

Newer DNN models are known to be larger and deeper than previously known DNN models. Consequently, newer DNN models may require more computation resources (e.g., memory and processing resources) than are available on computing systems that have been used for training known DNN models. Most DNN models can be trained using computation resources provided by, for example, a cloud computing system, assuming that the cloud computing has sufficient computation resources for training the DNN model. A user device (e.g., ED 110) with a DNN model having a particular architecture, a training dataset for training the DNN model and a training goal for the DNN model may not have access to computation resources to train the DNN model. To benefit from a powerful remote computing systems, such as a cloud computing system, the user device may be expected to transmit, to the remote computing system, all the specifications of the DNN model to be trained, including the architecture of the DNN, the training dataset and the training goal. Accordingly, the user device is expected to trust the remote computing system and grant the remote computing system full authorization to manipulate its intellectual property (the architecture of the DNN model, the training dataset used to train the DNN model and the training goal for the DNN model).

Three major issues may be identified in the traditional method of training a DNN model, as outlined hereinbefore. One issue is related to perceived weak protection of privacy and intellectual property. Another issue is related to the quantity of traffic involved in the transmission of a training dataset to a remote computing system, such as a cloud computing system, which performs the training of a DNN model. A further issue is related to perceived low efficiency of a method of training a DNN model that involves FP and BP (hereinafter referred to as a bidirectional training method).

With regard to the perceived weak protection of privacy and intellectual property, an architecture of a DNN model, a clean and well-prepared training dataset and a user-specified training goal may all be considered to be intangible intellectual properties of high value and/or the private to the user of the remote computing system. Although many countries and regions (e.g., the European Union) enact the laws to protect these properties, there exists no inherent technical security against any infringement of these intangible intellectual properties and user privacies.

With regard to the traffic involved in the transmission of a training dataset, a training dataset is typically divided into a number of batches and each batch may include hundreds or thousands of data samples. Each data sample may be a high-dimensional vector, representative of an image, a digital representation of text (e.g., a word of a sentence) or a sequence of images (e.g., a video). During training of a DNN model, a user device (e.g., ED 110) is expected to request a great amount of bandwidth to handle the transmission of the training dataset to a remote computing system that hosts a DNN model, such as a cloud computing system. In one option, the training dataset is transmitted continuously, batch by batch, to the remote computing system. In another option, the entirety of the training dataset is transmitted to the remote computing system. When there are a large number of users performing their training cycles, the transmission network, either wireless or wired, could suffer from having excess traffic.

With regard to the perceived low efficiency in a conventional bidirectional training method, the sequential nature of BP may be shown to cause difficulty in building a versatile high-throughput computing pipeline. Such a difficulty may be shown to hinder simple, divide-and-conquer parallelization of the computations of the layers of a DNN model. For example, a 20-layer DNN model (i.e., a DNN model that has 20 layers) may be divided into two disjointed groups: the first 10 layers forming a first group, “A”; and the second 10 layers forming a second group, “B.” While a computing system is performing the computations of each layer in group A is inference result using FP on a first batch, a computing system that performs the computations of each layer of group B must be remain idle and wait for the computing system performing the computations of group A to finish. Further, while group B is carrying out BP on a second batch, group A must also be idle and wait for group B to finish. Because the computation complexity of FP and BP are not proportional, single-direction DNN training methods are sought after. Single-direction DNN training methods are expected to lead to increased flexibility and implementation efficiency. No new training methods have, thus far, never resulted in a trained DNN model whose performance is substantially similar to the performance of a trained DNN model which was trained using conventional bidirectional training methods. The high-quality performance of the BP method is mainly attributed to convolutional filters and adversarial modelling goals. It can be shown that BP is able to tune convolutional filters that extract key features, textures or topologies in terms of the gradients propagated from proceeding layers. The gradients propagated from proceeding layers are known to contain information on the training goal. According to a known information bottleneck principle, the BP method reinforces, during the training procedure, two adverse agents: distortion; and matching. These two agents are expected to compete against each other until a balance is achieved, that is, until the learning converges.

In overview, aspects of the present disclosure relate to a method of training a DNN that involves using only FP to update parameters of the DNN model until the parameters of the DNN model are optimized (referred to hereinafter as a FP-only method of training a DNN model). It may be shown that single-directional (FP-only) training methods disclosed herein result in a trained DNN model whose performance is comparable to a DNN model that has been trained using a bidirectional (FP and BP) training method. The FP-only training method, according to aspects of the present disclosure, may be shown to operate without a need to employ the chain rule when updating the parameters of the DNN model. As mentioned hereinbefore, the chain rule is employed to compute gradients of a loss function during BP pass when a DNN model is trained using a bidirectional training method. The FP-only training method, according to aspects of the present disclosure, enables computations of each layer of the DNN model to be performed in parallel during trained of the DNN model. The FP-only training method l uses SGD to compute optimize the parameters of the DNN model and, accordingly, the FP-only method still involve computing gradients of a loss function. However, the FP-only training method computes gradients of a loss function without using the chain rule.

The FP-only training method may be used to train DNN models, for example convolutional neural network (CNN) models. The FP-only training method may be able to extract features with varying scales and perspectives from input data samples input to the DNN model. The FP-only method may result in a trained a DNN model whose performance is similar to the performance of a DNN model that has been trained using a bidirectional (BP) training method.

The FP-only training method may be shown to significantly compress the training dataset, including both the input data samples included in input dataset, X, and the ground truth data samples included in the ground truth dataset, Y. The compression of the kernel matrix inherently increase the entropy of the training dataset, which allows for the privacy of a user to be guarded.

The FP-only training method may be able to “hide” the training goal or objective from edge computing nodes performing computations of intermediate layers of a DNN model. This may be regarded as beneficial in that the training goal for a DNN model may be considered private to a given user.

The FP-only training method may offer the possibility of flexible, scalable and parallelizable computations of the layers of a DNN model during training that could save computation resources compared with bidirectional training methods. An independence associated with the computations of a gradient of a loss function for each layer allows for the FP-only training method to converge asynchronously rather than synchronously, as is the case for bidirectional training methods.

Consider splitting a DNN model into a first section and a second section at some point, i. The first section includes the input layers and i intermediate layers. The input layer of the DNN model receives input data samples x from the input dataset, X, and a last intermediate layer of the first section generates an activation map, Tᵢ. The first intermediate layer i+1 of the second section receives the activation map, Tᵢ as an input, and a last layer of the DNN model generates inference results. It may be observed that, throughout the course of training, the activation map, Tᵢ, exhibits increasingly lower correlation with the input data, X, and an increasingly higher correlation with the inference results y. It may be considered that there are two adverse agents: one agent is related to distortion between the activation map, Tᵢ, and the input data samples x obtained from the input dataset X; and another agent is related to matching between the activation map, Tᵢ, and the inference results y, for the input data samples x. It is permissible that matching happens more than distortion or that distortion happens more than matching. The parameters of the DNN model may not converge until a balance is achieved.

It is widely considered, mistakenly, that the parameters of the layers of a DNN model must be optimized according to the information bottleneck principle sequentially. More accurately, it may be considered that the information bottleneck theory only describes a phenomenon. A sequential method of enforcing the information bottleneck principle layer by layer of the DNN model is a result of known bidirectional training methods being inherently sequential. It is proposed herein that parameters of a given layer of a DNN model ought to be optimized according to the information bottleneck principle at a pace/rate specific to the given layer of the DNN model.

It may be considered that, in known bidirectional training methods, the information bottleneck principle is enforced implicitly. Bidirectional training methods do not include explicit computation of mutual information because the information bottleneck principle is enforced implicitly. Additionally, bidirectional training methods do not include changing mutual information directly. A determination of mutual information,

$$I ( X ; Y ) = \int \int p ( x , y ) \cdot log \frac{p ( x , y )}{p ( x ) \cdot p ( y )} dxdy ,$$

p(x), p(y) and p(x,y) are difficult to obtain from discrete samples. Moreover, the input dataset, X, to the DNN model and the inference dataset, Y, of the DNN model are likely to have different dimensionality. It follows that the mutual information, I(X;Y), can be only approximated from input data that is real data.

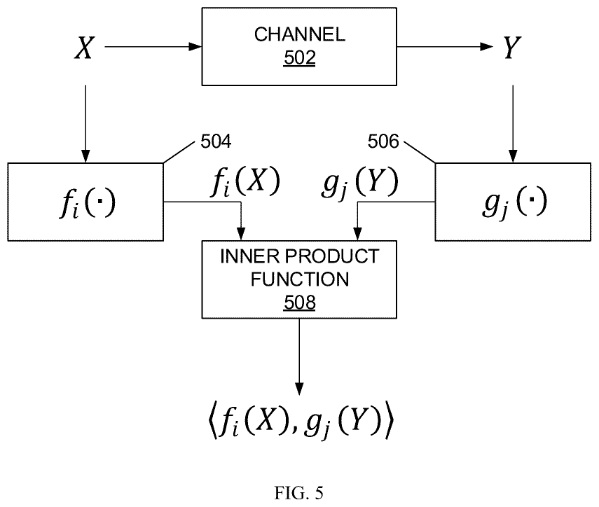

FIG. 5 illustrates, in a block diagram, of a process 502 which defines a relationship between random variables X, Y and measuring functions. The process 502 receives input, X E R^{m×D}^{ₓ}, representative of m samples, with each sample having a Dₓ-by-1 dimension. The process 502 generates output, Y∈R^{m×D}^{_{y}}, representative of m samples, with each sample having D_{y}-by-1 dimension. A measuring function 504, ƒᵢ(⋅), may be defined for mapping the input, X, from R^{m×D}^{ₓ} to R^{m×n} and a measuring function 506, gⱼ(⋅), may be defined for mapping the output, Y, from R^{m×D}^{_{y}} to R^{m×n}. The outputs, ƒᵢ(X) and gⱼ(Y), of the measuring functions 504, 506, may be received by an inner product function 508. It may be recognized that the inner product, [symbol] ƒᵢ(X),gⱼ(Y) [symbol] , of the outputs, ƒᵢ(X) and gⱼ(Y), of be determined by the inner product function 508 because the outputs are of the same dimension, m×n.

Following the definition of

$$I ( X ; Y ) = \int \int p ( x , y ) \cdot log \frac{p ( x , y )}{p ( x ) \cdot p ( y )} dxdy ,$$

we define

$$\begin{matrix}C [ {f}_{i} ( X ) , {g}_{j} ( Y ) ] & = \begin{matrix}\int \int 〈 {f}_{i} ( X ) , {g}_{j} ( Y ) 〉 \cdot p ( x , y ) dxdy − \\ \int \int 〈 {f}_{i} ( X ) , {g}_{j} ( Y ) 〉 \cdot p ( x ) \cdot p ( y ) dxdy\end{matrix} \\ & = \begin{matrix}{E}_{( x , y ) ∼ p ( x , y )} [ 〈 {f}_{i} ( X ) , {g}_{j} ( Y ) 〉 ] − \\ 〈 {E}_{x ∼ p ( x )} [ {f}_{i} ( x ) ] , {E}_{y ∼ p ( y )} [ {g}_{j} ( y ) ] 〉\end{matrix}\end{matrix}$$

where E_{(x,y)˜p(x,y)}[ [symbol] ƒᵢ(X),gⱼ(Y) [symbol] ] is the expectation of the inner product [symbol] ƒᵢ(X),gⱼ(Y) [symbol] and [symbol] E_{x˜p(x)}[ƒᵢ(x)],E_{y˜p(y)}[gⱼ(y)] [symbol] is the inner product of the expectations. According to fundamental inequality, if and only if the input, X, and the output, Y, are independent (X⊥Y), then C[ƒᵢ(X),gⱼ(Y)]=0. This is exactly as: if and only if the input, X, and the output, Y, are independent (X⊥Y), then I(X;Y)=0. Note that the mutual information function C[ƒᵢ(X),gⱼ(Y)] is valid for discrete samples, whereas the mutual information function I(X;Y) is valid for continuous variables.

Given a pair of mapping functions ƒᵢ(X) and gⱼ(Y), it may be observed that:

$$\begin{matrix}{( C [ {f}_{i} ( X ) , {g}_{j} ( Y ) ] )}^{2} = {( {E}_{( x , y ) ∼ p ( x , y )} [ 〈 {f}_{i} ( X ) , {g}_{j} ( Y ) 〉 ] − 〈 {E}_{x ∼ p ( x )} [ {f}_{i} ( x ) ] , {E}_{y ∼ p ( y )} [ {g}_{j} ( y ) ] 〉 )}^{2} \\ = {\underbrace{{{( 〈 {E}_{( x , y ) ∼ p ( x , y )} [ 〈 {f}_{i} ( X ) ] , {g}_{j} ( Y ) 〉 ] )}^{2}}_{\\}} +}_{A} {\underbrace{{{( 〈 {E}_{x ∼ p ( x )} [ {f}_{i} ( x ) ] , {E}_{y ∼ p ( y )} [ {g}_{j} ( y ) ] 〉 )}^{2}}_{\\} - 2}}_{B}\end{matrix} \cdot {〈 \underbrace{{E}_{( x , y ) ∼ p ( x , y )} [ 〈 {f}_{i} ( X ) , {g}_{j} ( Y ) 〉 ] , 〈 {E}_{x ∼ p ( x )} [ {f}_{i} ( x ) ] , {E}_{y ∼ p ( y )} [ {g}_{j} ( y ) ] 〉 〉}}_{C}$$

The (A) portion of the right-hand-side (“RHS”) may be expanded as:

$$\begin{matrix}{( {E}_{( x , y ) ∼ p ( x , y )} [ 〈 {f}_{i} ( X ) , {g}_{j} ( Y ) 〉 ] )}^{2} = \begin{matrix}{E}_{( {x}_{1} , {y}_{1} ) ∼ p ( x , y )} [ {( {f}_{i} {( {x}_{1} )}^{T} \cdot {g}_{j} ( {y}_{1} ) )}^{T} ] \\ {E}_{( {x}_{2} , {y}_{2} ) ∼ p ( x , y )} [ {f}_{i} {( {x}_{2} )}^{T} \cdot {g}_{j} ( {y}_{2} ) ]\end{matrix} \cdot \\ = {E}_{( {x}_{1} , {y}_{1} ) ∼ p ( x , y ) , ( {x}_{2} , {y}_{2} ) ∼ p ( x , y )} [ {f}_{i} ( {x}_{1} ) \cdot {f}_{i} {( {x}_{2} )}^{T} \cdot {g}_{j} {( {y}_{1} )}^{T} \cdot {g}_{j} ( {y}_{2} ) ] \\ = {E}_{( {x}_{1} , {y}_{1} ) ∼ p ( x , y ) , ( {x}_{2} , {y}_{2} ) ∼ p ( x , y )} [ 〈 〈 {f}_{i} ( {x}_{1} ) , {f}_{i} ( {x}_{2} ) 〉 , 〈 {g}_{j} ( {y}_{1} ) , {g}_{j} ( {y}_{2} ) 〉 〉 ]\end{matrix}$$

The (B) portion of the RHS may be expanded as:

$${( 〈 {E}_{x ∼ p ( x )} [ {f}_{i} ( x ) ] , {E}_{y ∼ p ( y )} [ {g}_{j} ( y ) ] 〉 )}^{2} = {( {E}_{x ∼ p ( x )} [ {( {f}_{i} ( x ) )}^{T} ] \cdot {E}_{y ∼ p ( y )} [ {g}_{j} ( y ) ] )}^{2} = \\ {( {E}_{{x}_{1} ∼ p ( x )} [ {f}_{i} {( {x}_{1} )}^{T} ] \cdot {E}_{{y}_{1} ∼ p ( y )} [ {g}_{j} ( {y}_{1} ) ] )}^{T} = {E}_{{x}_{2} ∼ p ( x )} [ {f}_{i} {( {x}_{2} )}^{T} ] \cdot {E}_{{y}_{2} ∼ p ( y )} [ {g}_{j} ( {y}_{2} ) ] = \\ {E}_{{x}_{1} ∼ p ( x ) , {x}_{2} ∼ p ( x ) , {y}_{1} ∼ p ( y ) , {y}_{2} ∼ p ( y )} = [ 〈 〈 {f}_{i} ( {x}_{1} ) , {f}_{i} ( {x}_{2} ) 〉 , 〈 {g}_{j} ( {y}_{1} ) , {g}_{j} ( {y}_{2} ) 〉 〉 ] .$$

The (C) portion of the RHS may be expanded as:

$$〈 {E}_{( x , y ) ∼ p ( x , y )} [ 〈 {f}_{i} ( X ) , {g}_{j} ( Y ) 〉 ] , 〈 {E}_{x ∼ p ( x )} [ {f}_{i} ( x ) ] , {E}_{y ∼ p ( y )} [ {g}_{j} ( y ) ] 〉 〉 = {( {E}_{( {x}_{1} , {y}_{1} ) ∼ p ( x , y )} [ {f}_{i} {( {x}_{1} )}^{T} \cdot {g}_{j} ( {y}_{1} ) ] )}^{T} \cdot {E}_{{x}_{2} ∼ p ( x )} [ {f}_{i} {( {x}_{2} )}^{T} ] \cdot {E}_{{y}_{2} ∼ p ( y )} [ {g}_{j} ( {y}_{2} ) ] = {E}_{( {x}_{1} , {y}_{1} ) ∼ p ( x , y ) , {x}_{2} ∼ p ( x ) , {y}_{2} ∼ p ( y )} [ 〈 〈 {f}_{i} ( {x}_{1} ) , {f}_{i} ( {x}_{2} ) 〉 , 〈 {g}_{j} ( {y}_{1} ) , {g}_{j} ( {y}_{2} ) 〉 〉 ]$$

Finally, denote Ω_{ƒ}_{ᵢ}_{,g}_{ⱼ}(x₁,x₂,y₁,y₂)= [symbol] [symbol] ƒᵢ(x₁),ƒᵢ(x₂) [symbol] [symbol] gⱼ(y₁),gⱼ(y₂) [symbol] [symbol] as inner products of inner products given a pair of mapping functions, ƒᵢ(⋅) and gⱼ(⋅).

$${( C [ {f}_{i} ( X ) , {g}_{j} ( Y ) ] )}^{2} = {E}_{( {x}_{1} , {y}_{1} ) ∼ p ( x , y ) , ( {x}_{2} , {y}_{2} ) ∼ p ( x , y )} [ {Ω}_{{f}_{i} , {g}_{j}} ( {x}_{1} , {x}_{2} , {y}_{1} , {y}_{2} ) ] + {E}_{{x}_{1} ∼ p ( x ) , {x}_{2} ∼ p ( x ) , {y}_{1} ∼ p ( y ) , {y}_{2} ∼ p ( y )} [ {Ω}_{{f}_{i} , {g}_{j}} ( {x}_{1} , {x}_{2} , {y}_{1} , {y}_{2} ) ] - 2 \cdot {E}_{( {x}_{1} , {y}_{1} ) ∼ p ( x , y ) , {x}_{2} ∼ p ( x ) , {y}_{2} ∼ p ( y )} [ {Ω}_{{f}_{i} , {g}_{j}} ( {x}_{1} , {x}_{2} , {y}_{1} , {y}_{2} ) ]$$

In mathematics, a Hilbert-Schmidt Independence Criterion (HSIC) Measurement is defined so that [symbol] (X;Y)=E_{ƒ}_{ᵢ}_{,g}_{ᵢ}(C[ƒᵢ(x),gⱼ(Y)])² may be referenced as an HSIC distance.

$$ℋ ( X ; Y ) = {{E}_{fi , gj} ( C [ {f}_{i} ( X ) , {g}_{j} ( Y ) ] )}^{2} = {E}_{( {x}_{1} , {y}_{1} ) ∼ p ( x , y ) , ( {x}_{2} , {y}_{2} ) ∼ p ( x , y )} [ 〈 {E}_{{f}_{i}} [ 〈 {f}_{i} ( {x}_{1} ) , {f}_{i} ( {x}_{2} ) 〉 ] , {E}_{{g}_{j}} [ 〈 {g}_{j} ( {y}_{1} ) , {g}_{j} ( {y}_{2} ) 〉 ] 〉 ] + {E}_{{x}_{1} ∼ p ( x ) , {x}_{2} ∼ p ( x ) , {y}_{1} ∼ p ( y ) , {y}_{2} ∼ p ( y )} [ 〈 {E}_{{f}_{i}} [ 〈 {f}_{i} ( {x}_{1} ) , {f}_{i} ( {x}_{2} ) 〉 ] , {E}_{{g}_{j}} [ 〈 {g}_{j} ( {y}_{1} ) , {g}_{j} ( {y}_{2} ) 〉 ] 〉 ] - 2 \cdot {E}_{( {x}_{1} , {y}_{1} ) ∼ p ( x , y ) , {x}_{2} ∼ p ( x ) , {y}_{2} ∼ p ( y )} [ 〈 {E}_{{f}_{i}} [ 〈 {f}_{i} ( {x}_{1} ) , {f}_{i} ( {x}_{2} ) 〉 ] , {E}_{{g}_{j}} [ 〈 {g}_{j} ( {y}_{1} ) , {g}_{j} ( {y}_{2} ) 〉 ] 〉 ]$$

where E_{ƒ}_{ᵢ}[ [symbol] ƒᵢ(x₁),ƒᵢ(x₂ [symbol] ] should be the expectation of the inner products with all the measuring functions, ƒᵢ(⋅), and where E_{g}_{ⱼ}[ [symbol] gⱼ(y₁),gⱼ(y₂) [symbol] ] should be the expectation of all the measuring functions, gⱼ(⋅). However, there are an infinite number of measuring functions ƒᵢ(⋅) and gⱼ(⋅). According to kernel theory, the law of large numbers allows for the use of kernel functions, k_{ƒ}(x₁, x₂) and k_{g}(y₁, y₂), to represent these expectations, where

$${E}_{{f}_{i}} [ 〈 {f}_{i} ( {x}_{1} ) , {f}_{i} ( {x}_{2} ) 〉 ] = {k}_{f} ( {x}_{1} , {x}_{2} )$$

$$and$$

$${E}_{{g}_{j}} [ 〈 {g}_{j} ( {y}_{1} ) , {g}_{j} ( {y}_{2} ) 〉 ] = {k}_{g} ( {y}_{1} , {y}_{2} ) .$$

Thus, the HSIC distance, [symbol] (X;Y), may be represented as

$$ℋ ( X ; Y ) = {E}_{( {x}_{1} , {y}_{1} ) ∼ p ( x , y ) , ( {x}_{2} , {y}_{2} ) ∼ p ( x , y )} [ 〈 {k}_{f} ( {x}_{1} , {x}_{2} ) , {k}_{g} ( {y}_{1} , {y}_{2} ) 〉 ] + {E}_{{x}_{1} ∼ p ( x ) , {x}_{2} ∼ p ( x ) , {y}_{1} ∼ p ( y ) , {y}_{2} ∼ p ( y )} [ 〈 {k}_{f} ( {x}_{1} , {x}_{2} ) , {k}_{g} ( {y}_{1} , {y}_{2} ) 〉 ] - 2 \cdot {E}_{( {x}_{1} , {y}_{1} ) ∼ p ( x , y ) , {x}_{2} ∼ p ( x ) , {y}_{2} ∼ p ( y )} [ 〈 {k}_{f} ( {x}_{1} , {x}_{2} ) , {k}_{g} ( {y}_{1} , {y}_{2} ) 〉 ]$$

Usually, the kernel functions, k_{ƒ}(x₁, x₂) and k_{g}(y₁, y₂), are preselected based on the suitability of the application.

Some known algorithms for FP methods involve training a DNN by searching the best kernel functions. It may be shown that none of these known algorithms have proven successful with good training performance.

Because the HSIC distance, [symbol] (X;Y), is easier to measure than the mutual information function, I(X;Y), the HSIC distance is often used to replace the mutual information function, I(X;Y), in practice, especially for a discrete data set. Since the batch size, m, usually exceeds 100, we can safely choose the Gaussian kernel function:

$${E}_{{f}_{i}} [ 〈 {f}_{i} ( {x}_{1} ) , {f}_{i} ( {x}_{2} ) 〉 ] = {k}_{f} ( {x}_{1} , {x}_{2} ) = {e}^{− \frac{{‖ {x}_{1} − {x}_{2} ‖}^{2}}{{{σ}_{f}}^{2}}}$$

$${E}_{{g}_{j}} [ 〈 {g}_{j} ( {y}_{1} ) , {g}_{j} ( {y}_{2} ) 〉 ] = {k}_{g} ( {y}_{1} , {y}_{2} ) = {e}^{− \frac{{‖ {y}_{1} − {y}_{2} ‖}^{2}}{{{σ}_{g}}^{2}}}$$

It follows that the HSIC distance, [symbol] (X;Y), may be expressed in terms of variances, σ_{ƒ}²,σ_{g}²:

$${ℋ}_{{σ}_{f} , {σ}_{g}} ( X ; Y ) = {E}_{( {x}_{1} , {y}_{1} ) ∼ p ( x , y ) , ( {x}_{2} , {y}_{2} ) ∼ p ( x , y )} [ 〈 {e}^{− \frac{{‖ {x}_{1} − {x}_{2} ‖}^{2}}{{σ}_{{f}^{2}}}} , {e}^{− \frac{{‖ {y}_{1} − {y}_{2} ‖}^{2}}{{σ}_{g} 2}} 〉 ] + {E}_{{x}_{1} ∼ p ( x ) , {x}_{2} ∼ p ( x ) , {y}_{1} ∼ p ( y ) , {y}_{2} ∼ p ( y )} [ 〈 {e}^{− \frac{{‖ {x}_{1} − {x}_{2} ‖}^{2}}{{σ}_{{f}^{2}}}} , {e}^{− \frac{{‖ {y}_{1} − {y}_{2} ‖}^{2}}{{σ}_{{g}^{2}}}} 〉 ] - 2 \cdot {E}_{( {x}_{1} , {y}_{1} ) ∼ p ( x , y ) , {x}_{2} ∼ p ( x ) , {y}_{2} ∼ p ( y )} [ 〈 {e}^{− \frac{{‖ {x}_{1} − {x}_{2} ‖}^{2}}{{{σ}_{{f}^{2}}}^{}}} , {e}^{− \frac{{‖ {y}_{1} − {y}_{2} ‖}^{2}}{{σ}_{{g}^{2}}}} 〉 ]$$

Aspects of the present disclosure relate to using the Gaussian kernel function. Moreover, supplied variances may be considered to be representative of different resolutions to measure the data samples.

Training is done batch by batch (or epoch by epoch). A batch includes m input samples and m output samples. The HSIC distance may be evaluated as

$$( X ; Y ) = \frac{1}{{m}^{2}} \cdot {\sum }_{u = 1}^{m} {\sum }_{v = 1}^{m} 〈 {k}_{f} ( {x}_{u} , {x}_{v} ) , {k}_{g} ( {y}_{u} , {y}_{v} ) 〉 + \frac{1}{{m}^{4}} \cdot {\sum }_{u = 1}^{m} {\sum }_{v = 1}^{m} {\sum }_{i = 1}^{m} {\sum }_{j = 1}^{m} 〈 {k}_{f} ( {x}_{u} , {x}_{v} ) , {k}_{g} ( {y}_{i} , {y}_{j} ) 〉 - 2 \cdot \frac{1}{{m}^{3}} \cdot {\sum }_{u = 1}^{m} {\sum }_{v = 1}^{m} {\sum }_{i = 1}^{m} 〈 {k}_{f} ( {x}_{u} , {x}_{v} ) , {k}_{g} ( {y}_{u} , {y}_{j} ) 〉$$

At this point, an input kernel matrix, K_{ƒ}(X), may be introduced, along with a label kernel matrix, K_{g}(Y):

$${K}_{f} ( X ) = [ \begin{matrix}{k}_{f} ( {x}_{1} , {x}_{1} ) & ⋯ & {k}_{f} ( {x}_{m} , {x}_{1} ) \\ ⋮ & ⋱ & ⋮ \\ {k}_{f} ( {x}_{1} , {x}_{m} ) & ⋯ & {k}_{f} ( {x}_{m} , {x}_{m} )\end{matrix} ] \\ {K}_{g} ( Y ) = [ \begin{matrix}{k}_{g} ( {y}_{1} , {y}_{1} ) & ⋯ & {k}_{g} ( {y}_{m} , {y}_{1} ) \\ ⋮ & ⋱ & ⋮ \\ {k}_{g} ( {y}_{1} , {y}_{m} ) & ⋯ & {k}_{g} ( {y}_{m} , {y}_{m} )\end{matrix} ]$$

The HSIC distance between an m-sized input, X, and an m-sized output, Y, may be expressed as:

$$( X ; Y ) = \frac{1}{{m}^{2}} \cdot trace ( 〈 {K}_{f} ( X ) , {K}_{g} ( Y ) 〉 ) + \frac{1}{{m}^{4}} \cdot trace ( 〈 {K}_{f} ( X ) \cdot 1 , {K}_{g} ( Y ) \cdot 1 〉 ) - 2 \cdot \frac{1}{{m}^{3}} \cdot trace ( 〈 {K}_{f} ( X ) , {K}_{g} ( Y ) \cdot 1 〉 ) = \frac{1}{{m}^{2}} \cdot trace ( 〈 {K}_{f} ( X ) \cdot J , {K}_{g} ( Y ) \cdot J 〉 )$$

### Where

$$1 = {[ \begin{matrix}1 & ⋯ & 1 \\ ⋮ & & ⋮ \\ 1 & ⋯ & 1\end{matrix} ]}_{m \times m}$$

(all-one matrix) and

$$J = I - \frac{1}{m} \cdot 1.$$

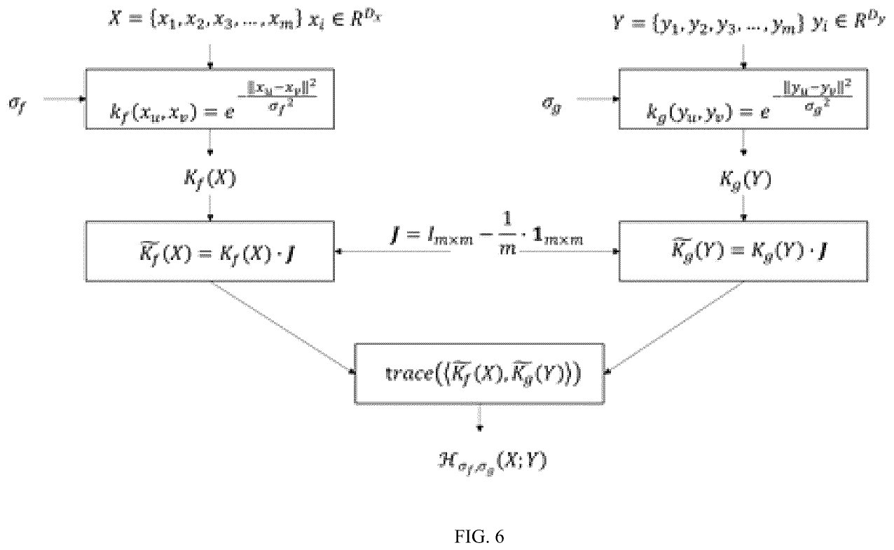

FIG. 6 illustrates a manner of determining the HSIC distance, [symbol] _{σ}_{_{ƒ}}_{,σ}_{_{g}}(X;Y).

Indeed, in the following, the HSIC distance, [symbol] _{σ}_{_{ƒ}}_{,σ}_{_{g}}(X;Y), may be used in place of the mutual information function, I(X;Y), when observing a training cycle.

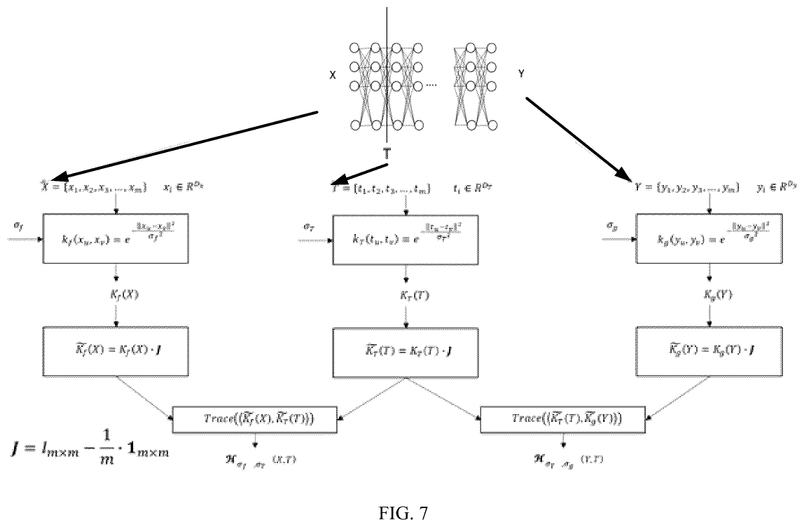

FIG. 7 illustrates an HSIC-based Information Bottleneck Principle.

It may be shown that when HSIC distances are used during training of a DNN model, each iteration of training the DNN model demonstrates the same tendencies observed during the bidirectional training of the DNN model. That is, a matching followed by a distortion may be observed during an iteration of training the DNN model that use HSIC distances. When training the DNN model using a batch of training data (e.g., a batch of input data samples obtained from the input dataset X and corresponding ground truth data sample obtained from the ground truth dataset Y), as \tilde{K}_{ƒ}(X) and \tilde{K}_{g}(Y) remain unchanged, the training objective of the DNN model is to tune the activation (Tᵢ) such that

$${T}_{i}^{⋆} = {argmin}_{{P}_{{T}_{i} \vert X}} {ℋ}_{{σ}_{f} , {σ}_{{T}_{i}}} ( X ; {T}_{i} ) − β \cdot {ℋ}_{{σ}_{{T}_{i}} , {σ}_{g}} ( {T}_{i} ; Y ) .$$

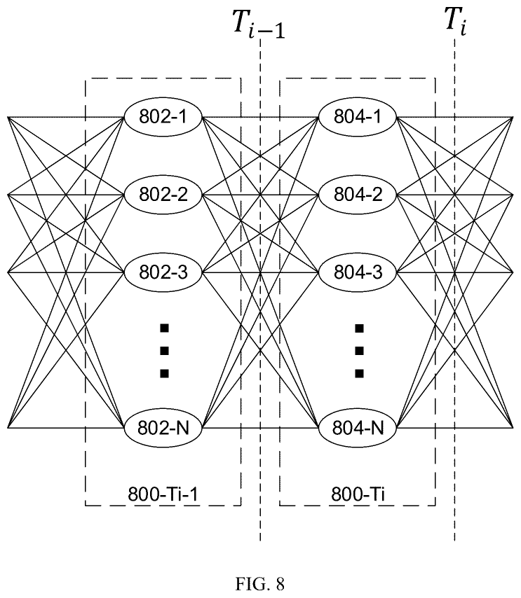

FIG. 8 illustrates a representation of two consecutive intermediate layers of a DNN model. In particular, FIG. 8 illustrates an intermediate layer 800(Tᵢ₋₁) and an intermediate layer 800(Tᵢ) of a DNN model. The DNN model also includes an input layer (not shown), an output layer (not shown), one or more intermediate layers between the input layer (not shown) and the intermediate layer 800(Tᵢ₋₁), and one or more intermediates layers (not shown) between intermediate layer 800(800(Tᵢ) and the output layer (not shown). The intermediate layer 800(Tᵢ₋₁) includes a plurality of neurons 802-1, 802-2, 802-3, . . . , 802-N (individually or collectively 802). The layer 800 (Tᵢ) includes a plurality of neurons 804-1, 804-2, 804-3, . . . , 804-N (individually or collectively 804). An activation map (i.e., feature map), denoted Tᵢ₋₁, is generated by the intermediate layer of the layer 800(Tᵢ₋₁) based on an activation map of a preceding intermediate layer (not shown) of the DNN model, and the activation map Tᵢ₋₁ is the input to the subsequent intermediate layer 800(Tᵢ). An activation map (i.e., feature map) Tᵢ is generated by the intermediate layer 800(Tᵢ) based on the activation map Tᵢ₋₁. An action function of an intermediate layer may be denoted Zᵢ(⋅;θᵢ), may represent conversion of the input activation map, Tᵢ₋₁, into the output activation map, Tᵢ by the intermediate layer 800(Tᵢ). That is intermediate layer 800(Tᵢ) performs the computation, Tᵢ=Zᵢ(Tᵢ₋₁;θᵢ). The coefficients, θᵢ, may be understood to represent parameters for the neurons 804 of the intermediate layer 800(Tᵢ). The activation map Tᵢ₋₁ generated by the intermediate layer 800(Tᵢ₋₁) includes a plurality of activations, one for each neuron in the intermediate layer 800(Tᵢ₋₁). Similarly, activation map Tᵢ generated by the intermediate layer 800(Tᵢ) includes a plurality of activations, one for each neuron in the intermediate layer 800(Tᵢ).

The training goal for the Tᵢ layer 800(Tᵢ) is to reinforce the information bottleneck principle,

$${θ}_{i}^{⋆} = {argmin}_{{θ}_{i}} {ℋ}_{{σ}_{f} , {σ}_{{T}_{i}}} ( X ; {Z}_{i} ( {T}_{i − 1} , {θ}_{i} ) ) − β \cdot {ℋ}_{{σ}_{{T}_{i}} , {σ}_{g}} ( {Z}_{i} ( {T}_{i − 1} , {θ}_{i} ) ; Y ) ,$$

by optimizing the coefficients, θᵢ.

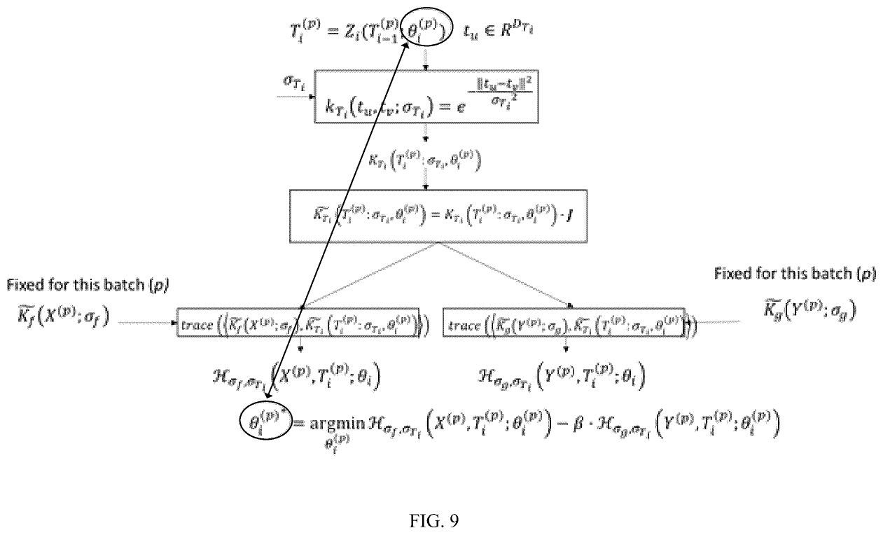

FIG. 9 illustrates explicit reinforcement of HSIC-based Information Bottleneck on the activation function, Zᵢ(⋅,θᵢ) of intermediate layer i, on a p^{th} batch of training data.

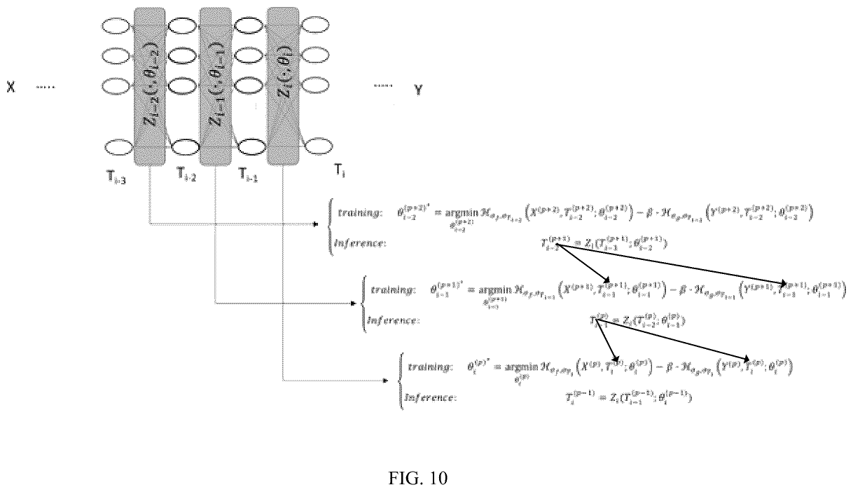

FIG. 10 illustrates three consecutive intermediate layers of a DNN model forming a computing pipeline, as will be discussed hereinafter.

In view of FIG. 10, an intermediate layer of a DNN model, denoted intermediate layer i−2, has an activation function, Zᵢ₋₂(⋅,θᵢ₋₂), that is generated from the input data samples of the (p+2)^{th} batch of training data. The output of the activation function, Zᵢ₋₂(⋅,θᵢ₋₂), is an activation map (e.g., feature map), Tᵢ₋₂^{(p+1)}, to be associated with (p+1)^{th} batch of training data, X^{(p+1)} and Y^{(p+1)}. Notably, values for coefficients (e.g., parameters), θᵢ₋₂^{(p+1)}, are obtained using input data samples of a previous batch of training data, that is, the (p+1)^{th} batch of training data.

In further view of FIG. 10, an intermediate layer of the DNN model, denoted intermediate layer i−1 layer has an activation function Zᵢ₋₁(⋅,θᵢ₋₁), that is generated from the input data samples of the (p+1)^{th} batch of training data, X^{(p+1)} and Y^{(p+1)}. The output of the activation function, Zᵢ₋₁(⋅,θᵢ₋₁), is an activation map (e.g., feature map), Tᵢ₋₁^{(p)}, to be associated with p^{th} batch of training data. Notably, values for coefficients, θᵢ₋₁^{(p)}, are obtained using input data samples of a previous batch of training data, that is, the p^{th} batch of training data.

In even further view of FIG. 10, an intermediate layer of the DNN model, denoted intermediate layer i has an activation function, Zᵢ(⋅,θᵢ), that is generate from the input data samples of the p^{th} batch of training data. The output of the layer function, Zᵢ(⋅,θᵢ), in an activation map (e.g., feature map), Tᵢ^{(p-1)}, to be associated with (p−1)^{th} batch of training data. Notably, values for coefficients, θᵢ^{(p-1)}, are obtained using input data samples from a previous batch of training data, that is, the (p−1)^{th} batch of training data.

Unlike known bidirectional methods for training a DNN model, methods for training a DNN model according to aspects of the present disclosure operate as a flow (i.e., are unidirectional) from input to output on a batch by batch (epoch by epoch) basis. As such, methods of training a DNN model according to aspects of the present application offer potential for building hardware implementation of a high-throughput computing pipeline. From a data storage perspective, a computing system that computes the activation function, Zᵢ₋₁(⋅,θᵢ₋₁) of a layer of a DNN model, simply stored as an activation map (e.g., feature map), Tᵢ₋₂^{(p+1)}, computed based on the activation map (e.g., feature map) of a preceding layer and kernel matrices for the current batch, X^{(p+1)} and Y^{(p+1)}. The computing system performing the computation of an intermediate layer of the DNN model may then provide an activation map (e.g., feature map), Tᵢ₋₁^{(p)}, to a computing system that performs the computation of a following layer (e.g., intermediate layer or the output layer) of the DNN model.

Given a DNN model with activation functions, Tᵢ, i=1, 2, . . . . N, a batch of training data comprising input data samples from an input dataset, X, and corresponding ground truth data samples obtained from a ground truth dataset, Y, a loss, Lᵢ, for an i^{th} layer may be computed using an information bottleneck (IB) loss function, Lᵢ=I(X;Tᵢ)−βI(Y;Tᵢ), where β is a positive integer scalar to balance the two mutual information measurements. In practice, the mutual information I(A;B) between two random variables A and B is very difficult to compute efficiently or accurately; this may be seen as particularly true of random variables based on real-world data. Recall, from the preceding, that there exists, as an alternative approximation of the mutual information, a measure called the Hilbert-Schmidt Independence Criterion (HSIC). The HSIC measurement of two random variables A and B is written as [symbol] (A;B) and can take on a statistical meaning that is similar to mutual information, that is, [symbol] (A;B)≈I(A;B). The HSIC measurement can be explicitly determined as

$$( A ; B ) = \frac{1}{{( m - 1 )}^{2}} tr ( {K}_{A} J {K}_{B} J )$$

where m is the size of the batch size of training data obtained from the training dataset from variables A and B; K_{A} and K_{B} are normalized square symmetric kernel matrices of dimension m×m, determined from their respective m input data samples in the current batch of training data; tr( ) is trace function; a J matrix is the centering matrix defined as

$$J = {I}_{m} - \frac{1}{m} \cdot {1}_{m}$$

where Iₘ is the m×m identity matrix; and 1 is the square all-one matrix. With this definition, an IB loss function, Lᵢ, may be expressed as Lᵢ= [symbol] (X;Tᵢ)−β· [symbol] (Y;Tᵢ).

The IB loss function, Lᵢ, benefits from first determining kernel matrices of X, Y and Tᵢ. A kernel matrix, K_{A}, may be defined as K_{Aij}=k̅(aᵢ,aⱼ), where one-aᵢ,aⱼ, are one-dimensional vectors and the function k(⋅) represents a selected kernel function. The most commonly selected kernel function is a Gaussian kernel function, also known as a Radial Basis Function (“RBF”). It should be clear that many different kinds of kernel functions could be used selected, if desired. The Gaussian kernel function, k(i,j), may be computed as

$$k ( i , j ) = exp ( - \frac{{‖ i - j ‖}^{2}}{2 {σ}^{2}} )$$

where σ is a hyperparameter of the DNN model that is be tuned (i.e., optimized) to ensure the performance of the DNN model is as good as possible. The kernel may then be normalized to the range [0,1], to obtain a normalized kernel, k̅(i,j), as follows:

$$\overline{k} ( i , j ) = \frac{k ( i , j )}{max ( ‖ k ( i , j ) ‖ , ∈ )} , ∈ << 1.$$

For each layer, i of a DNN model, and for each training iteration, the IB loss function, Lᵢ, may be evaluated once.

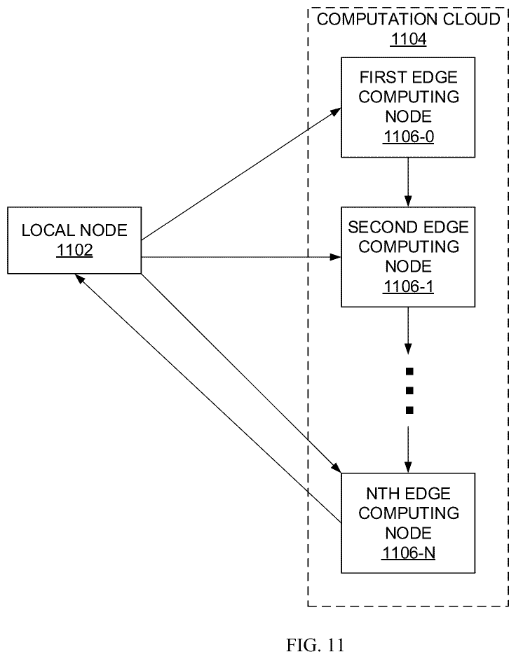

FIG. 11 illustrates a local computing system (otherwise referred to as a local node) 1102 and a plurality of distributed computing systems 1106-0, 1106-1, . . . , 1106-N (e.g., computing nodes) that communicate with the local node 1102. The local node 1102 and the plurality of distributed edge computing nodes 1106-0, 1106-1, . . . , 1106-N (generally referred to as edge computing node 1106 and collectively referred to as edge computing nodes 1106) are configured to the FP-only method of training a DNN model. As illustrated in FIG. 11, the local node 1102 communicates with a first edge computing node 1106-0, a second edge computing node 1106-1 and an nth edge computing node 1106-N via a wireless networks and/or wired networks of communication system 100, such as networks 120, 130, 140, and 150. It will be understood that the local node 1102 may communicate with as few as one edge computing node 1106 or an arbitrary number of edge computing nodes 1106.

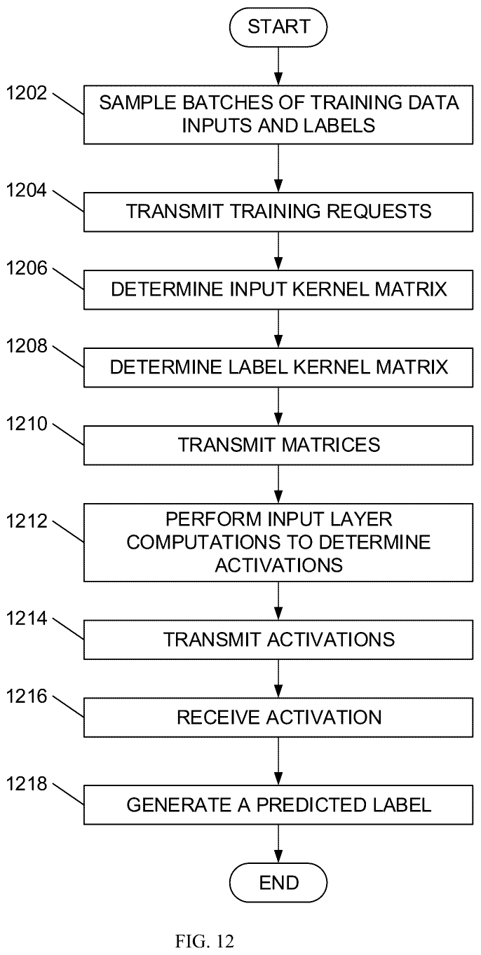

FIG. 12 illustrates example steps in a FP-only method for training a DNN model in accordance with the present disclosure. The examples steps of the FP-only method for training a DNN model shown in FIG. 12 are carried out (e.g., performed) at the local node 1102. The local node 1102 may be an ED 110. Accordingly, in the following, steps that are indicated to be performed by the local node 1102 may be understood to be performed by a processor of an ED 110, such as the processor 210.

The steps of a FP-only method for training a DNN model shown in FIG. 12 may begin with the local node 1102 sampling (step 1202) batches of training data. Each batch of training data comprising a plurality (e.g., m) input data samples sampled from the input dataset X (7040 and a plurality (e.g., m) of ground truth data samples sampled the ground truth dataset Y. Each input data sample in each batch of training data includes a corresponding input data sample sampled from the input dataset X.

The local node 1102 transmits (step 1204), to the edge computing nodes 1106, training requests. For simplicity, in this example, it will be assumed that one edge computing node 1106 implements a single intermediate layer of the DNN model. It will be understood that, in practice, an edge computing node 1106 may implement several consecutive intermediate layers of the DNN model. Each training request, transmitted, by the local node 1102 in step 1204, may be understood to contain hyperparameters. The hyperparameters, transmitted in a training request to a given edge computing node 1106, may include an indication of a number of neurons in the intermediate layer implemented by the given edge computing node 1106, an indication of whether or not normalization is used, an indication of convolutional filters and sub-channelization, an indication of a size of the batch (or kernel size) of the training data, an indication of an identity for an input (source) edge computing node 1106, and an indication of an identity for an output (destination) edge computing node. The input (source) edge computing node 1106 is the edge computing node 1106 that precedes the given edge computing node 1106. That is, the input (source) edge computing node 1106 is the edge computing node 1106 from which the given edge computing node 1106 is to receive an activation map comprising activation data of the preceding intermediate layer of the DNN model. The output (destination) edge computing node 1106 is the edge computing node 1106 that follows the given edge computing node 1106. That is, the output (destination) edge computing node 1106 is the edge computing node 1106 to which the given edge computing node 1106 transmits an activation map comprising activation data generated by computations of the intermediate layer performed by the given edge computing node 1106. Note that no training goal is included in the training request, because the edge computing nodes 1106 perform the computations of their respective layers of the DNN model to minimize a MIB loss. Note, also, that, in a case wherein three consecutive edge computing nodes 1106 are provided from three different companies, it may be considered that user privacy is enhanced.

For each respective batch of training data, the local node 1102 may determine (step 1206) an input kernel matrix based on input data samples included the respective batch of training data. The local node 1102 may also determine (step 1208) a label kernel matrix based on the ground truth labels included in the respective batch of training data. The local node 1102 may then transmit (step 1210), to the first edge computing node 1106-0, the input kernel matrix and the label kernel matrix.

Further training flexibility can be provided by using a number of parallel branches with a different parameter, σᵢ, associated with each the activation map Tᵢ of each intermediate layer i. In a simple scenario, the activation map Tᵢ of an intermediate layer i is a vector of activations. However, the activation map, Tᵢ, for an intermediate layer can be made up of a number (q) of vectors, wherein each vector corresponds to a branch. Kernel matrix determinations (steps 1206 and 1208) may be carried out with a unique parameter, σ, for each branch. The division of the computations of intermediate layers of a DNN model may be referred to as “partitioning.” Notably, even in view of partitioning, the architecture of a DNN model remains unchanged. Indeed, the partitioning only affects the manner in which the loss and gradients are computed for each layer of the DNN model. A loss is determined for each partition in a given layer of the DNN model according to a different resolution dictated by the hyperparameter, σ. The additional freedom afforded by partitioning an intermediate layer into q partitions comes at a cost of increased computation complexity by in that q kernel matrices are determined for a given layer of the DNN model. Conveniently, though, partitioning allows for a more intricate analysis of the input data samples in a batch of training data, due to the diversity of parameters, σ.

For the determination of each kernel matrix, a value for the hyperparameter, σ, is to be selected. This selection may be simplified by using a default value such as 0.5 for all intermediate layers of the DNN model. However, use of such a default value is not expected to yield optimal performance for the trained DNN model. The selection of the hyperparameter, σ, can, in aspects of the present disclosure, be tediously selected by trial and error. Alternatively, in other aspects of the present disclosure, the hyperparameter, σ, may be tuned automatically, as part during training of the DNN model using the FP-only method for training the DNN model of the present application. In the scenario wherein the hyperparameter, σ, is tuned automatically and is learned along with the parameters (e.g., weights and biases) of each layer of the DNN model, the hyperparameter, σ, may be considered to be misnamed as a hyperparameter and, instead, may be called a model parameter. It is also possible that each layer of the DNN model could have different model parameter, σ. From a geometrical or topological point of view, the model parameter, σ, represents a resolution from which to observe the training data of a particular batch of training data. For a relatively small value for the model parameter, σ, the resolution is considered to be relatively high. For a DNN model, and especially for a CNN model, as a result of different convolutional filters and sub-channels, different layers of the DNN model process incoming activation map with varying resolution. Naturally, distinct resolutions may be applied at distinct layers of the DNN model. From this perspective, it may be shown to be trivial to optimize the model parameter, σ, using the same SGD method used to tune the parameters (e.g., weights and biases) of the DNN model. Other automatic tuning procedures for optimizing the hyperparameter σ can also be considered.

The local node 1102 may further compute (step 1212) the activations maps, T₀, for the input layer of the DNN model generated based on the input data samples in the batch of training data. The computing (step 1212) of activation maps, T₀, in particular, may involve the local node 1102 performing computations associated with the input layer, i=0, of the DNN model on the basis of the input data samples in a respective batch of training data.

Furthermore, the performing (step 1212) the computations of the input layer involves computing an input layer gradient (i.e., computing a gradient for the input layer of the DNN model) and, once the input layer gradient has been computed, stepping the input layer gradient. The term “stepping,” in the context of the input layer gradient, may be understood to involve updating values of the parameters (e.g., weights and biases) of the neurons of the input layer. The goal of the stepping, or updating, is to minimize a loss value.

In aspects of the present application, computing the input layer gradient involves computing a loss value. In particular, as discussed hereinbefore, the loss value, L, may be computed using a MIB loss function, which may be based on an HSIC measurement. The input layer gradient may then be computed based on the determined loss value.

Continuing operation, then, the local node 1102 may transmit (step 1214), to the first edge computing node 1106-0, the plurality of input layer activations. Though not illustrated as a step, the local node 1102 may also transmit, to the other edge computing nodes 1106, pluralities of respective layer activations.

The local node 1102 may subsequently receive (step 1216), from the nth edge computing node 1106-N, an activation map generated by an nth (last) intermediate layer. As discussed hereinbefore, the nth edge computing node 1106-N is configured to perform computations of an nth (a last) intermediate layer of the DNN model.

The local node 1102 may then perform the computations of the output layer of the DNN model to generate (step 1218) an inference result. The computations are performed (step 1218) on the basis of the activation maps generated by the nth last intermediate layer received in step 1216.

Aspects of the present disclosure relate to establishing a FP-based method for training a DNN model using a local node and a plurality of edge computing nodes which communicate with each other using networks 120, 130, 140, 150 of a communication system 100a. Such a method of training a DNN model may be shown to suit local nodes that would like to train a DNN model but lack sufficient local computation resources to do so. In aspects of the present disclosure, FP-based method for training a DNN model may be carried out in one of two modes: a boomerang training mode; and a hybrid training mode.

In the boomerang training mode, an input layer, a first intermediate layer, a last intermediate layer, and an output layer a DNN model are deployed at the local node 1102, while the rest of the intermediate layers of the DNN model are implemented at edge computing nodes 1106. In a typical DNN model, such as a CNN model, the sizes of the layers of the DNN model (dimensionality of Tᵢ) are typically established such that the input layer of the DNN model aligns with the dimensionality of the input data samples, the following layers increase the sizes of the layers by two-dimensional convolutional filter channels and the last layers decrease the sizes of the layers for the classification or embedding, etc. It follows that benefits may be realized by offloading the some of the intermediate layers of the DNN model, which are known to be computation-heavy, to the computing nodes 1106 having a large amount of computation resources. Because computation of intermediate layers of the DNN model could be grouped and performed in parallel to realize a general goal of reducing information bottleneck, different intermediate layers could be computed by the computing nodes 1106. No gradients are passed among the consecutive groups or layers in the cloud. Rather than transmitting raw input data samples sampled from the input dataset, X, and corresponding ground truth data samples (e.g., ground truth labels) sampled from the ground truth dataset, Y, the local node 1102 transmits (multicasts, step 1210) kernel matrices K_{X}(X) and K_{Y}(Y) to each edge computing node 1106 for each batch of training data. As mentioned above, transmission bandwidth is reduced, user data and training privacy is guaranteed because the input data samples and the corresponding ground truth data samples (e.g., ground truth labels) cannot be inferred from kernel matrices K_{X}(X) and K_{Y}(Y). The last intermediate layer and the output layer of the DNN model, which are deployed at the local node 1102, could use traditional BP during training of the DNN model to update the parameters of these layers (e.g., weights and biases of the neurons of these layers) to fulfill a specific training goal. This method for DNN training acts like the boomerang training mode in that the training method starts at the local node 1102 and ends at the local node 1102. Since there is only forward propagation is performed during training of a DNN model, from one group of intermediate layers deployed at an edge computing node 1106, to the following group of intermediate layers deployed at an edge computing node 1106, two distinct groups of layers deployed at two distinct edge computing nodes 1106, can be assigned to different providers of the edge computing nodes. For example, the first group of intermediate layers deployed at the first edge computing node 1106-0, may be assigned to provider A of the edge computing node 1106-0. A second group of intermediate layers deployed at the second edge computing node 1106-1, may be assigned to a second provider that provides edge computing node 1106-1. Notably, only activation maps are transmitted from edge computing node 1106-0 to edge computing node 1106-1. In this way, a local node 1102 need not disclose the architecture of an entire DNN model to an edge computing node. Another byproduct of FP-based method of training a DNN model is that the groups of layers do not necessarily converge synchronously, as occurs in BP-based methods for training a DNN model. The later groups of layers could start performing their computations later than the beginning ones. Overall, FP-based method for training a DNN model of the present disclosure may be optimized to save computation resources compared with BP-based methods of training a DNN model.

In a hybrid training mode, a DNN model could be divided into two DNNs, depth-wise. For example, a 20-layer DNN model could be considered a two super-layer (or two group) DNN model, with each super-layer/group containing 10 layers of the DNN model. Each layer in the DNN model may be denoted as Tᵢ^{j}, where j represents a super-layer/group number and i represents a layer number of the DNN model. Then, for this two-group DNN model, FP-based methods for training the DNN model may be utilized. The FP-based methods for training the DNN model may be configured to maximize a dependence between K_{X}(X) and K_{T}_{₁₀}_{¹}(T₁₀¹) and minimize the dependence between K_{T}_{₁₀}_{¹}(T₁₀¹) and K_{Y}(Y) for group 1 and to minimize task loss between a predicted outputs, Ŷ (represented by last layer T₂₀²), and a ground truth data samples, Y, for group 2. Furthermore, the maximizing and the minimizing may be carried out in parallel. For the first super latent layer, T¹, a BP-based method for training a DNN model may be used on the first 10 layers to optimize, T¹, to realize the information bottleneck goal. Similarly, a BP-based method for training a DNN model may be used on the second super latent layer, T², to realize the information bottleneck goal. In this way, the FP only method offers a top-level, divide-and-conquer parallelization. A BP-based method for training a 20-layer DNN model could be divided into smaller DNN models whose computations are performed in parallel. This type of modification may be seen to be highly compatible with modern, distributive edge computing systems. Suppose that each edge computing node has computation resources that limit the unit to carry out a maximum 10-layer BP-based method for training a DNN model. In the hybrid mode, several low-power edge computation nodes could work together (in parallel) to, thereby, accomplish training of a very deep DNN model. Note that there is no gradient passed from the second super latent layer, T², to the first super latent layer, T¹, and that the gradients are passed backward only within the 10 layers within a super latent layer. In conclusion, both BP-based methods for training a DNN model and FP-based methods for training a DNN model may be used together in order to match the computation environment.

The HSIC-based training and kernel matrix determination discussed hereinbefore can be shown to facilitate traditional deep learning on a single computing node, such as the local node 1102. More importantly, this type of training may also be shown to facilitate disjointed training modes, including the aforementioned boomerang and hybrid training modes. Kernel matrices can be sent between edge computing nodes in lieu of training data or intermediate model parameters. It is an entropy-increasing operation to compute the kernel matrices from the training dataset (input data samples and ground truth data samples (e.g., ground truth labels) respectively). Therefore, user data privacy is protected in the sense that no user-specific information could be inferenced back from the kernel matrices. For each computing node on which a layer of a DNN model is deployed would receive two kernel matrices at each epoch, update the parameters of the layer with the HSIC-based IB loss function and output the activation map of the layer to the next computing node one which a following layer of the DNN model is deployed. All training data and model parameters (e.g., weights and biases of a DNN model) can remain local to the originating user during the training of a DNN model. Even though data and model parameters are kept local, relevant training information can be communicated along inter-node edges safely using kernel matrices and unintelligible layer activations.

Aspects of the present disclosure may be shown to allow for flexible training graphs by splitting the DNN model that is to be trained into layers that are convenient for the physical limitations of the scenario. The DNN model can be split into any number of layers that can be deployed to edge computing nodes 1106 for performing computations during training of the DNN model. The edge computing nodes 1106 are able to update the parameters of their layer during training of the DNN model by a HSIC-based information bottleneck training goal without access to local private user data but with access to kernel matrices. Conveniently, a DNN model is distributable among edge computing nodes 1106 for training the DNN model according to scenario constraints and allows user data and user training goals to be protected from edge computing nodes 1106.

The methods of training a DNN model represented by aspects of the present disclosure may also be shown to allow for bandwidth efficiency, due to the numerical structure of kernel matrices. The resulting kernel matrices computed from a single batch of training data are very likely to require less memory for storage and less wireless bandwidth for transmission compared with the raw input data samples or the model parameters used in other methods of training a DNN model. Using, as an example, the Modified National Institute of Standards and Technology database, a large database of handwritten digits that is commonly used for training various DNN models which perform a computer vision task, an input data sample is a single image consisting of a 28 by 28 array of 32-bit floating point pixels when normalized, which amounts to 3136 bytes per image. A training data set having a batch size of 64 (i.e., 64 images) requires 196 MB of memory. If the input data samples (e.g., the images) were to be exchanged during a method of training a DNN model which employs traditional backwards propagation, 196 MB would be transmitted every iteration of training. Training a DNN model using the methods of aspects of the present disclosure, a kernel matrix determined (step 1206) from the same batch of training data size yields a 64 by 64 symmetric matrix of floating-point numbers, which requires only 16 MB of memory to store. Other existing decentralized schemes for training a DNN model, such as federated learning, do not exchange raw input data samples but, instead, exchange model parameters (or gradients). Most effective DNN models, such of CNN models are known to require hundreds of megabytes of data to store their parameters.

Aspects of the present disclosure discussed hereinbefore relate to distributable forward-only methods of training a DNN model. It may be shown that limitations exist within these approaches. Each disjointed layer is trained to directly optimize the HSIC-based information bottleneck principle:

$${T}_{i}^{*} = {argmin}_{{T}_{i}} ( X ; {T}_{i} ) - β ( Y ; {T}_{i} )$$

In other words, the parameters of each layer, i, are optimized to minimize the HSIC distance between activation map of the i^{th} layer and input data sample input to the DNN model, as well as to maximize the HSIC distance between activation maps of the i^{th} layer and a ground truth data samples (e.g., ground truth labels) for the input data sample. The information bottleneck principle operates on assumptions about the simplicity of the system. Namely, X, Y, and Tᵢ, are each assumed to be single, multi-dimensional, sets of random variables. The information bottleneck principle assigns no importance to the quality of the activation maps, Tᵢ. In many simple DNN models, each layer, i, involves a matrix multiplication with the parameters of the i^{th} layer followed by a chosen activation function. This results in a single, multi-dimensional, vector of random variables and maintains a simple representation. However, there are other types of activation maps that are computed using more complex means, such as a convolutional layer in a CNN. Convolution layers take advantage of spatial correlations within input data samples, which are images, and produce hidden representations (i.e., activation maps) that are extractions, or features, of the input data sample (i.e., image). Cascading convolutional layers can create a very high-quality hidden representation (i.e., activation map) when the CNN is trained using the traditional backward propagation. Both the information bottleneck principle and convolutional filters result in a trained model that has high accuracy in generating inference results (e.g., detecting objects). However, the forward propagation methods discussed hereinbefore may not guarantee convolutional filter quality, since the information bottleneck principle is enforced directly.

To further improve the performance of the forward propagation methods discussed hereinbefore, we modify the IB loss function by taking into account the quality of the activation map, Tᵢ. This modification minimizes the entropy of the activation map, Tᵢ:

$${T}_{i}^{*} = {argmin}_{{T}_{i}} ( X ; {T}_{i} ) - β \cdot ( Y ; {T}_{i} ) + γ \cdot H ( {T}_{i} )$$

where γ is a new scaling constant. Minimizing the entropy of the activation map, Tᵢ, can be shown to help ensure that the activation map, Tᵢ, take on meaning. Thus, the quality of the activation map, Tᵢ, can be improved.

The entropy, H(Tᵢ), is preferably simple to compute in practice. Generally speaking, the mutual information, I(A;B), of any two random variables, A and B, can be expressed in terms of their entropies:

$$I ( A ; B ) = H ( A ) - H ( A \vert B )$$

Further, the mutual information of any random variable with itself reduces the equation to the entropy of that random variable:

$$I ( A ; A ) = H ( A ) - H ( A \vert A )$$

$$I ( A ; A ) = H ( A ) - 0$$

$$I ( A ; A ) = H ( A )$$

Using the same replacement used in aspects of the present disclosure discussed hereinbefore, the entropy of any random variable, A, can be approximated by the HSIC function:

H(A)≈ [symbol] (A;A)

This approximation allows for a new, modified information bottleneck (MIB) loss function that is HSIC-based and can be used to train complex DNN models such as those in a CNN model:

$${L}_{i} = ( X ; {T}_{i} ) - β ( Y ; {T}_{i} ) + γ ( {T}_{i} ; {T}_{i} )$$

It should be noted that the HSIC function, [symbol] (⋅;⋅), expects two-dimensional operands. Each random variable operand should have the same batch dimension as the first operand dimension and any number of further dimensions of the random variable should be flattened to a single dimension, as the second operand dimension.

The MIB loss function can be shown to be useful because the MIB loss function provides for a trained DNN model whose performance that is comparable to a DNN model trained using traditional backward propagation. With the original IB loss function, discussed hereinbefore, the activation maps generated by layers of the DNN model, such as a convolutional layers, have a tendency to collapse to a simplistic and useless representation.

On the surface, aspects of the present disclosure discussed to this point may be shown to facilitate training of a DNN model, such as a CNN model, so that no backwards pass is required as a result of the elimination of the chain rule. The lack of a backward pass has several implications.

In a first implication, layers of a DNN model whose parameters are updated with the IB loss function or with the MIB loss function do not have data dependencies in the backward direction. As a result, layers who parameters are updated in this way can be have their parameters updated in parallel once a forward pass is completed. More specifically, a layer i gradient for each layer, i, can be computed as soon as forward propagation (i.e., a forward pass) for layer i is completed.

In a second implication, layers of a DNN model updated with the IB loss function or the MIB loss function may precede a non-differentiable operation, since no chain rule is required in the backward direction. This possibility allows for a much more complex and practical computation graph in the forward direction. Any number of useful non-differentiable operations, or “layers,” may be placed in the middle of the DNN model. Operations such as random sampling, noise application, binarization/quantization, entropy-based compression or even error correction coding can be used as part of the DNN model.

In a third implication, a DNN model may be trained in a distributed manner, while maintaining data privacy. Training of a DNN model f may be delegated to powerful edge computing nodes. The prospect of parallelizable, or at least distributable, deep learning allows for this kind of distributed training of a DNN model. An edge computing node 1106 that transmits activation functions and kernel matrices to another edge computing node 1106 need not maintain a differentiable communication, since no backward propagation will be performed during training. This allows for the freedom that results from use of a distribution scheme that makes use of any number of traditional compression or error correction techniques. Data privacy of training data is maintained as a result of the fact that updates to the parameters of intermediate layers of a DNN model during training that are delegated to edge computing nodes 1106 only uses activation maps from previous layers and kernel matrices derived from the training data. The intermediate training edge computing nodes 1106 do not require raw data so long as the first and last layers of the DNN are trained at the local node 1102.

In view of these three implications, a secure and distributable forward-only method for training a DNN model is provided. Given the local node 1102, U, with input data samples obtained from an input dataset, X, ground truth data samples (e.g., ground truth labels) obtained from a ground truth dataset, Y, a set of n edge computing nodes 1106, R={R₀, R₁, . . . , Rₙ₋₁}, and given a DNN model with n+2 layers, i={0, 1, . . . , n+1}, of which n+1 layers are intermediate (i.e., i layers), T={T₀, T₁, . . . , Tₙ}, the DNN model can be trained using the FP method as follows.

For each epoch, the local node 1102 may randomly sample q batches of training data comprising m input data samples sampled from the input dataset, X, and m corresponding ground truth data samples (e.g., ground truth labels) sampled from the ground truth dataset Y. Thus, each batch of training data has a size m (e.g., a batch size “m”). From the batches of training data, the local node 1102 may determine (steps 1204 and 1206, see FIG. 12) 2q kernel matrices, K. The 2q kernel matrices, K, includes q kernel matrices, K_{X}, for the input data samples of each batch of training data, and q kernel matrices, K_{Y}, for the ground truth data samples (e.g., ground truth labels) for each batch of training data. The local node 1102 may then transmit (step 1210) the 2q kernel matrices, K, to all of the edge computing nodes 1106.

A forward pass (e.g., forward propagation) of the method of training of the DNN model may then begin. The local node 1102 may perform input layer (layer 0) computations to generate an activation map for the input layer (referred to hereinafter as input layer activation map), T₀. The local node 1102 may compute a gradient for the input layer (i.e., layer 0 of the DNN model) using a MIB loss. The local node 1102 may then step the gradient for the input layer using gradient descent. The local node 1102 may transmit (step 1214) the input layer activation, T₀, to the first edge computing node 1106-0.

The first edge computing node 1106-0, upon receipt of the input layer activation map, T₀, and in view of having received the set of 2p kernel matrices, K, may generate an activation map for the first intermediate layer of the DNN model (referred to hereinafter as a first intermediate layer activation map), T₁. The local node 1102 may compute a gradient for the first intermediate layer of the DNN model (e.g., layer 1 of the DNN model). The local node 1102 may also step the gradient for the first intermediate layer (e.g., layer 1) of the DNN model. The first edge computing node 1106-0 transmits the first intermediate layer activation map, T₁, to the second edge computing node 1106-1.

The second edge computing node 1106-1, upon receipt of the first intermediate layer activation, T₁, and in view of having received the set of 2p kernel matrices, K, may generate an activation map for the second intermediate layer of the DNN model (referred to hereinafter as a second intermediate layer activation map), T₂. The local node 1102 may compute a gradient for the second intermediate layer of the DNN model (e.g., layer 2 of the DNN model). The local node 1102 may also step the gradient for the second intermediate layer (e.g., layer 2) of the DNN model. The second edge computing node 1106-1 transmits the second intermediate layer activation map, T₂, to a further edge computing node 1106 (not shown).

The process of determining an activation map for an intermediate layer i of the DNN model (referred to hereinafter as an intermediate layer i activation map, Tᵢ, computing and stepping the gradient for intermediate layer, i, of the DNN model and then transmitting the intermediate layer i activation map, Tᵢ, to a further edge computing node 1106 may be continued until the nth edge computing node 1106-N, upon receipt of an intermediate layer activation map, Tₙ₋₁, and in view of having received the set of 2p kernel matrices, K, may generate a nth intermediate layer activation map, Tₙ. The local node 1102 may compute a gradient for the last intermediate layer n. The local node 1102 may also step the gradient for intermediate layer n of the DNN model. The nth edge computing node 1106-N transmits the nth intermediate layer activation map, Tₙ, to the local node 1102.

Upon receiving (step 1216), from the nth edge computing node 1106-N, the nth intermediate layer activation map, Tₙ, the local node 1102 generates (step 1218) an inference result. The local node 1102 also computes a gradient for the output layer (e.g., last layer) of the DNN model. The local node 1102 may then step the gradient for the output layer using a loss specified for the DNN model (mean squared error, cross-entropy, etc.).

In review, a stepping of the gradient, for each layer of a DNN model has been competed for an entire DNN model in a distributed fashion that disclosed no private training data to the edge computing nodes 1106. The method of training a DNN model illustrated in FIG. 12 may be performed q−1 more times, one time for each batch of training data remaining in the epoch. The method illustrated of training a DNN model in FIG. 12 can be repeated depth-wise over the length of the model (transmit a single activation map q times between each layer) or repeated batch-wise over within each layer (compute all q activation maps in each layer and then transmit all q activation maps in bulk). Further, gradient steps may be applied as the gradients are computed or the steps can be applied after all gradients in the entire DNN model have been computed. This choice can be left to implementation detail. The method of training a DNN model illustrated in FIG. 12 may be carried out for as many epochs as desired.

The culmination of all embodiments up until this point provides an array of benefits. The primary benefit is the allowance of a parallelizable and distributable training of a DNN model. Any low-powered local node 1102 with sufficient training data can off-load the work associated with training to edge computing nodes 1106 that may have high-powered computation resources or a series of nearby edge computing nodes 1106 that may have medium-powered computation resources. This distribution of training of a DNN model can be accomplished without compromising the integrity of the privacy of the training data or the training goal. The training process may be shown to be capable of training to completion while avoiding the transmission of input data samples and corresponding ground data samples (e.g., ground truth labels) to edge computing nodes 1106. Only kernel matrices and hidden representations transferred from one edge computing node 1106 to another edge computing node 1106. It is notably impossible to infer the input data samples from the kernel matrices and activation maps (i.e., hidden representations). The training data and beginning of the DNN model (e.g., the input layer and one or more subsequent intermediate layers of the DNN model) along with the training goal and output layer of the DNN model are all kept to the local node 1102.

The equations for determining the kernel matrix in aspects of the present disclosure, described hereinbefore, feature a tunable hyperparameter, σ, in the Gaussian kernel function, which is also known as RBF. The tunable hyperparameter, σ, has been discussed as being used to determine a resolution by which each layer analyzes the input, label, and activation data when computing its loss. Put another way, the tunable hyperparameter, σ, may be used to establish the extent to which two separate input data samples in a batch of training data interact with each other in the HSIC function that is used to approximate mutual information. As such, the tunable hyperparameter, σ, has an immense effect on the quality of the model obtained from training. Mathematically, any real number can be used as a value for the tunable hyperparameter, σ, but only specific values will produce a trained DNN model that has high accuracy and performance.

The tunable hyperparameter, σ, can exist as a single hyperparameter for an entire training iteration or the tunable hyperparameter, σ, can exist with high levels of flexibility. There can exist a unique tunable hyperparameter, σ, for each layer and/or a unique tunable hyperparameter, σ, for each kernel matrix and/or a unique tunable hyperparameter, σ, for each training iteration or epoch. There are no consistent rules for selecting the value of the tunable hyperparameter, σ. The tunable hyperparameter, σ, can be tuned by hand through trial-and-error, which may prove to be impossible in practical applications, or it can be tuned automatically.

Not only can the tunable hyperparameter, σ, be tuned automatically, the tunable hyperparameter, σ, can be learned during the course of the training a DNN model. A method of learning the tunable hyperparameter, σ, may begin with a step of initializing the tunable hyperparameter, σ, with a selected starting value, σᵢₙᵢₜ. The selected starting value may be selected by random selection or by selecting a consistent small value such as 1 or 0.5. During training of the DNN model, a unique tunable parameter, σ, for each kernel matrix, K, can be added to a list of parameters to be optimized for each layer, i of the DNN model. Using this technique, the tunable parameter, σ, is learned automatically as a parameter of the DNN model. During the course of training a DNN model, with careful experiment design, the tunable hyperparameter, σ, for each kernel matrix may be expected to converge to a stable value, thereby allowing the DNN model to be trained to sufficient accuracy. When computing a gradient for each layer of the DNN model, a further gradient may also be computed for the tunable hyperparameter, σ, where the further gradient is based on the MIB loss. As such, the tunable hyperparameter, σ, and the parameters (e.g., weights and biases) of the layer, i, of the DNN model will be optimized to minimize the MIB loss.

The Gaussian kernel function is very common function used in machine learning. This may be due to the Gaussian kernel function being adaptable and, accordingly, suitable for real-world data. When dealing with finite data, kernel matrices may be used in functions related to a comparison between pairs of training samples. The distance between two samples in Hilbert space may be determined by the tunable hyperparameter, σ, in the Gaussian kernel function. As such, the tunable hyperparameter, σ, may be shown to facilitate the adaptability of the Gaussian kernel function to allow for quality approximation of mutual information computation based on finite amount of training data samples. In practice, selecting the tunable hyperparameter, σ, in a manner that results in a high-accuracy performing DNN model, is a difficult task, because of the vast number of possible values the tunable hyperparameter, σ, can take on. Selecting a quality value for the tunable parameter, σ, may be considered important to the performance of the FP training methods representative of aspects of the present application. Incorporating a low-cost and automatic procedure for learning a value for the tunable parameter, σ, may be shown to facilitate the FP training methods of the present application.

In view of deploying a DNN model on a plurality of edge computing nodes for performing the computations of intermediate layers of the DNN model during a training using the FP training method of the present application, it may be supposed that training data comprising a number of input data samples and ground truth data samples (e.g., ground truth label), has a well-defined architecture (number of layers, normalization, etc.) and has a training objective. In view of FIG. 11, the user, at the local node 1102, has limited local computation resources and, accordingly, resorts to arranging use of network-based computing resources, especially on the edge of the network (the computation cloud 1104). On the network side, there are a number of edge computing nodes 1106 that are not as powerful as a computing system comprising a large number of GPUs/CPUs (commonly referred to as a GPU/CPU) farm. Each edge computing node 1106 may contain limited computation resources (e.g., processing and storage (or memory) resources). However, it is expected that each edge computing node 1106 is much more powerful than the local node 1102 but much less powerful than a cloud computing system or a computation data center. Moreover, the edge computing nodes 1106 may be provided by different companies, which would be beneficial to user privacy protection (e.g., protection of private data that is used as input data samples for training a DNN model).

At first, the local node 1102 transmits (step 1204), to the edge computing nodes 1106, training requests. For simplicity, in this example, it will be assumed that one edge computing node 1106 implements one layer of a DNN model. In other words, an input layer of the DNN model is deployed at the local node 1102. It will be understood that, in practice, an edge computing node 1106 may implement several consecutive intermediate (e.g., hidden) layers of the DNN model. In other words, several intermediate layers of the DNN model may be deployed at an edge computing node 1106. Each request, transmitted, by the local node 1102, in step 1204, may be understood to contain hyperparameters. The hyperparameters, transmitted in a request to a given edge computing node 1106, may include an indication of a number of neurons of the intermediate layer of the DNN model implemented at the given edge computing node 1106, an indication of whether or not normalization is used by the intermediate layer, an indication of convolutional filters and sub-channelization (if the DNN model is a CNN model), an indication of batch size (or kernel size), an indication of an identity for an input (source) edge computing node 1106, an indication of an identity for an output (destination) edge computing node, and so on. The input (source) edge computing node 1106 is the edge computing node 1106 that precedes the given edge computing node 1106. That is, the input (source) edge computing node 1106 is the edge computing node 1106 from which the given edge computing node 1106 is to receive an activation data map. The output (destination) edge computing node 1106 is the edge computing node 1106 that follows the given edge computing node 1106. That is, the output (destination) edge computing node 1106 is the edge computing node 1106 to which the given edge computing node 1106 transmits an activation map. Note that no training goal is included in the training request, because the edge computing nodes 1106 act to train the intermediate layers of the DNN model implemented thereon to minimize a MIB loss. Note, also, that, in a case wherein three consecutive edge computing nodes 1106 are provided from three different companies, it may be considered that user privacy is enhanced.

As discussed hereinbefore, aspects of the present disclosure include a specification that the first layer of the DNN model (e.g., the input layer of the DNN model) and the last layers (more than one layer) of the DNN model (e.g., the last intimidate layer and the output layer of the DNN model) are implemented at the local node 1102. This specification may be shown to provide a strict user data protection, because no input data samples are transmitted to the edge computing nodes 1106, only kernel matrices are transmitted. The edge computing nodes 1106, upon receiving a training request, may be expected to allocate an appropriate amount of computation resources to perform the computations of the intermediate nodes implemented thereon. Additionally, the edge computing nodes 1106, upon receiving a training request, may be expected to establish data channels in order to reliably transmit activation maps comprising activations between themselves. Notably, transmissions between the local node 1102 and the first edge computing node 1106-1 and transmission between the local node 1102 and the nth edge computing node 1106-N are expected to wireless transmission. In contrast, the (single direction) transmissions between two consecutive edge computing nodes 1106 may be established wired transmission or in a wireless transmissions. Note that, while the edge computing nodes 1106 may be considered to be “consecutive” within the context of the DNN model, the so-called “consecutive” edge computing nodes 1106 may be physically located far apart.

Once the transmission (step 1204) of the training requests is complete, the local node 1102 may start training the DNN model. The local node 1102 transmits (step 1210) the input kernel matrices and the output kernel matrices to the edge computing nodes 1106 batch by batch.

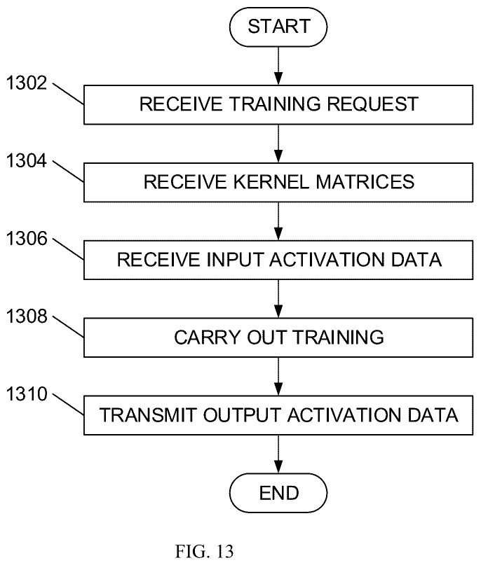

FIG. 13 illustrates example steps in a method of training of a DNN model that are carried out (e.g., performed) at a given edge computing node 1106. The given edge computing node 1106 receives (step 1302) one of the training requests transmitted by the local node 1102 in step 1204 (FIG. 12). Indeed, the training request received (step 1302) may be specific to the given edge computing node 1106. As discussed hereinbefore, the training request may include an indication of an identity for an input edge computing node 1106 and an indication of an identity for an output edge computing node. The given edge computing node 1106 may be expected to perform the computations of an intermediate node implemented at the given edge computing node (step 1308) responsive to receipt (step 1304) of an input kernel matrix and an output kernel matrix, transmitted by the local node 1102 in step 1210, in addition to receipt (step 1306) of activation map received from the input edge computing node 1106 indicated in the training request received (step 1302) from the local node 1102. After the given edge computing node 1106 computes an activation map (step 1308) for a particular batch of training data, the given edge computing node 1106 transmits (step 1310) the activation data map the output edge computing node 1106 indicated in the training request received (step 1302) from the local node 1102.

Because the activation map flows along a single direction, the training of a DNN model can be considered to form a pipeline, in which the given edge computing node 1106-i is performing computations and updating the parameters of an intermediate layer of the DNN model in view of the input kernel matrix and the output kernel matrix of the l^{th} batch of training data, the preceding edge computing node 1106-(i−1) is performing computations and updating parameters of the preceding layer of the DNN model in view of the input kernel matrix and the output kernel matrix of the (l+1)^{th} batch of training data and the proceeding edge computing node 1106-(i+1) is performing computations and updating parameters of the proceeding layer of the DNN model in view of the input kernel matrix and the output kernel matrix of the (l−1)^{th} batch of training data.

There are several options for transmitting (step 1210) the input kernel matrices and the output kernel matrices.

In a first option, all of the edge computing nodes 1106 receive input kernel matrices and the output kernel matrices with the same resolution, that is, the same tunable hyperparameter, σ, discussed hereinbefore. In this first option, the local node 1102 may be seen to “broadcast” the input kernel matrices and the output kernel matrices batch by batch to all the edge computing nodes 1106, or the input kernel matrices and the output kernel matrices may be transmitted with the activation maps.

In a second option, some of the edge computing nodes 1106 receive input kernel matrices and output kernel matrices with one resolution and some of the edge computing nodes 1106 receive input kernel matrices and output kernel matrices with another resolution. In this second option, the local node 1102 may be seen to “multicast” the input kernel matrices and the output kernel matrices with different resolutions batch by batch to corresponding sets of edge computing nodes 1106.

In a third option, each of the edge computing nodes 1106 receives input kernel matrices and output kernel matrices with a unique resolution. In this third option, the local node 1102 may be seen to “unicast” the input kernel matrices and output kernel matrices to individual edge computing nodes 1106.

In a fourth option, unlike the backwards-propagation-based methods for training a DNN model, the edge computing nodes 1106 may be configured to evolve asynchronously. It may be shown that often the parameters of the first several layers of a DNN model converge much faster than the parameters of the later layers of the DNN model. Accordingly, in the later iterations of training, the parameters that are updated are most likely to be the parameters of the later layers. Accordingly, a given edge computing node 1106 may be configured to stop updating parameters of a layer of a DNN model (e.g., stepping a layer of the DNN model) if the parameters have converged to the MIB loss target. After convergence (i.e., the parameters of a layer of the DNN model have converged), the edge computing node 1106 may be configured to only perform inference for the layer of the DNN model, on the basis of the activation map, using the learned parameters of the layer of the DNN model. The edge computing node 1106 may then output an activation map. Note that the local node 1102 may discontinue transmitting the kernel input matrices and the kernel output matrices to the edge computing nodes 1106 implementing a layer of the DNN model whose parameters have converged. As the inference is much simpler than training, the computation resources (including storage or memory) of these edge computing nodes 1106 may be released. Alternatively, once the parameter of an l^{th} edge computing node 1106 (implementing the l^{th} layer of the DNN model) converges, the l^{th} edge computing node 1106 may transmit the learned parameters for the l^{th} layer of the DNN model to the local node 1102 and get released. The local node 1102 may use the newly learned parameters for the l^{th} layer during inference. Then, the (l+1)^{th} edge computing node 1106 becomes the first edge computing node 1106 from the perspective of the local node 1102. Step by step, a boomerang chain becomes shorter until all of the edge computing nodes 1106 are released.

Conveniently, because the training of a DNN model is distributed over many edge computing nodes 1106, which are likely to be provided by distinct service providers, complete information of the architecture of the DNN model may be considered to be protected.

Furthermore, because each edge computing node 1106 has a MIB loss function as a training goal, information about the training goal is protected.

Moreover, because the computations and updating of the parameters of the first layer and the last layers of the DNN model are performed at the local node 1102 and only input kernel matrices and output kernel matrices are transmitted to the edge computing nodes 1106, any information regarding the input data samples used to train the DNN model is protected. Moreover, the act of determining an input kernel matrix may be seen as a compression. The amount of memory occupied by the input kernel matrix is likely to be significantly less than the amount of memory occupied by the input data samples in the training dataset, especially when sizes of the batches of training data are kept reasonably small.

It is further notable that, because each edge computing node 1106 interacts with an input (source) edge computing node 1106 and an output (destination) edge computing node 1106 in one direction, a relatively large amount of data can be transmitted from an input edge computing node to an output edge computing node 1106 through the computation nodes 1106.

Depending on a configuration of resolutions of the input kernel matrices and the output kernel matrices, the local node 1102 may “broadcast,” “multicast” or “unicast” the input kernel matrices and the output kernel matrices to the edge computation nodes 1106. If all of the edge computing nodes 1106 are given a kernel input matrix and an output kernel matrix with the same resolution, the kernelized input data samples may be configured to pass with activation data from the one edge computation node 1106 to the next edge computation node 1106.

Unlike conventional methods for training a DNN which employ BP aspects of the present application relate to FP-based only methods for training a DNN that are asynchronous, in that the edge computing nodes 1106 that have completed optimizing their parameters are released. The FP-based method of training a DNN efficiently uses of computation resources. In fact, the rate of convergence of the parameters may be viewed to be neither uniform temporally nor uniform spatially. Recall that, at the beginning of the training a DNN model, the edge computing nodes 1106 that perform the computations and optimization of the parameters of the beginning intermediate layers of the DNN model. The parameters of the beginning intermediate layers of the DNN model are expected to converge much faster than the parameters of the latter layers of the DNN model. It may be observed that about 50% of training data may be used to train the last 20% of the layers of a DNN model. This implies that 80% of the edge computing nodes 1106 may be released at the halfway point of the training a DNN model and that only 20% of the edge computing nodes 1106 would be left to work on the remainder of the DNN model.

In consideration of a batch of training data comprising m input data samples, {x₁, x₂, x₃, . . . , xₘ}, each input data sample, xᵢ∈R^{D}^{ₓ}, can be an image, a video, a representation of text and so on. Dₓ can easily be more than 1000 dimensions. For example, a batch of training data comprising 200 64-by-64 images would be 3.125 MB=4096×200×32 bits. The input kernel matrix, Kr, for this batch of training data may be shown to have 155.46 kB=200×(200−1)×32 bits, which may be shown to represent about 5% of the input data samples. If the Gaussian kernel function is used, both the input kernel matrix, K_{ƒ}(X), and the label kernel matrix, K_{g}(Y), may be shown to be symmetric matrices.

According to Kernel theory, all kernel functions are entropy-increasing operations. Both the input kernel matrix, K_{ƒ}(X), and the label kernel matrix, K_{g}(Y), represent some statistic commonality among the input data samples, {x₁, x₂, x₃, . . . , xₘ}, from which correlations are to be learned. No details about any single input data sample, xᵢ, are disclosed. That is, according to aspects of the present disclosure, user privacy with respect to the input data samples is maintained.

Regardless of the format of an input data sample xᵢ, both the input kernel matrix, K_{ƒ}(X), and the label kernel matrix, K_{g}(Y), may be shown to maintain the same format. That is, both the input kernel matrix, K_{ƒ}(X), and the label kernel matrix, K_{g}(Y), may be shown to be an m-by-m symmetric matrix. Such symmetric matrices may be shown to be relatively easy to standardize and protective of privacy of the input data samples. Furthermore, the format of the input data samples in the training data used to train a DNN model remains private.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method at a local computing node, the method comprising:
sampling input data samples from an input data set comprising a plurality of input data samples, and sampling ground truth data samples from a ground truth dataset comprising a plurality of ground truth data samples, each ground truth data sample in the ground truth dataset corresponding with one of the input data samples in the input dataset;
determining an input kernel matrix based on the sampled input data samples;
determining a label kernel matrix based on the sampled ground truth data samples;
transmitting, to a first edge computing node configured to perform computations of at least a first intermediate layer of at least one intermediate layer of a neural network, the input kernel matrix and the label kernel matrix;
performing computations of an input layer of the neural network, on the basis of the input kernel matrix and the label kernel matrix and parameters of the input layer, to generate an input layer activation map;
updating the parameters of the input layer on the basis of a loss computed for the input layer based on an input activation kernel matrix and the label kernel matrix, the input activation kernel matrix determined based on the input layer activation map;
transmitting, to the first edge computing node, the input layer activation map;
receiving, from a last edge computing node configured to perform computations of a last intermediate layer of the at least one intermediate layer of the neural network, a last intermediate layer activation map;
performing computations of an output layer of the neural network, on the basis of the last intermediate layer activation map and parameters of the output layer, to generate an inference result comprising predicted labels; and
updating the parameters of the output layer on the basis of a loss computed for the output layer on the basis the sampled training data labels and the predicted labels.

2. The method of claim 1, wherein updating the parameters of the input layer includes:
computing an input layer gradient; and
stepping the input layer gradient to update for the parameters of the input layer.

3. The method of claim 1, wherein the loss for the input layer is computed using a modified information bottleneck (MIB) loss function.

4. The method of claim 3, wherein the MIB loss function is based on a Hilbert-Schmidt Independence Criterion (HSIC).

5. The method of claim 1, wherein updating the parameters of the output layer includes:
computing an output layer gradient; and
stepping the output layer gradient to update the parameters of the output layer.

6. The method of claim 5, wherein the loss of the output layer is computed using a mean squared error loss function.

7. The method of claim 5, wherein the loss function is a cross-entropy loss function.

8. The method of claim 1, wherein the first edge computing node and the last edge computing node are among a plurality of edge computing nodes, and transmitting, to the first edge computing node configured to perform computations of at least the first intermediate layer of the at least one intermediate layer of the neural network, the input kernel matrix and the label kernel matrix comprises:
broadcasting, to the plurality of edge computing nodes, the input kernel matrix and the label kernel matrix.

9. The method of claim 1, wherein determining the input kernel matrix comprises defining the input kernel matrix as K_{Aij}=k̅(aᵢ,aⱼ), where aᵢ, aⱼ, are the sampled input data samples and k̅ function represents a normalized Gaussian kernel function, and the input data samples are one-dimensional vectors.

10. The method of claim 9, wherein computing the input kernel matrix comprises optimizing the normalized Gaussian kernel function k̅ based on a tunable hyperparameter for establishing an extent to which the two one-dimensional vectors interact with each other when using the input kernel matrix to approximate mutual information.

11. The method of claim 10, further comprising, before determining the normalized Gaussian kernel, selecting the tunable hyperparameter.

12. The method of claim 11, wherein selecting the tunable hyperparameter comprises selecting a default value.

13. The method of claim 11, wherein selecting the tunable hyperparameter selecting the hyperparameter using trial and error.

14. The method of claim 11, wherein selecting the parameter comprises selecting the hyperparameter using an automatic tuning procedure.

15. A local computing node, comprising:
one or more processors; and
a memory storing instructions which, when executed by the one or more processors cause the one or more processors to carry out operations comprising:
sampling input data samples from an input data set comprising a plurality of input data samples, and sampling ground truth data samples from a ground truth dataset comprising a plurality of ground truth data samples, each ground truth data sample in the ground truth dataset corresponding with one of the input data samples in the input dataset;
determining an input kernel matrix based on the sampled input data samples;
determining a label kernel matrix based on the sampled ground truth data samples;
transmitting, to a first edge computing node configured to perform computations of at least a first intermediate layer of at least one intermediate layer of a neural network, the input kernel matrix and the label kernel matrix;
performing computations of the input layer, on the basis of the input kernel matrix and the label kernel matrix and parameters of the input layer, to generate an input layer activation map;
updating the parameters of the input layer on the basis of a loss computed for the input layer based on an input activation kernel matrix and the label kernel matrix, the input activation kernel matrix determined based on the input layer activation map;
transmitting, to the first edge computing node, the input layer activation map;
receiving, from a last edge computing node configured to perform computations of a last intermediate layer of the at least one intermediate layer, a last intermediate layer activation map;
performing computations of an output layer of the neural network, on the basis of the last intermediate layer activation map and parameters of the output layer, to generate an inference result comprising predicted labels; and
updating the parameters of the output layer on the basis of a loss computed for the output layer on the basis the sampled training data labels and the predicted labels.

16. The local computing node of claim 15, wherein updating the parameters of the input layer includes:
computing an input layer gradient; and
stepping the input layer gradient to update the parameters of the input layer.

17. The local computing node of claim 15, wherein the loss for the input layer is computed using a modified information bottleneck (MIB) loss function.

18. The local computing node of claim 17, wherein the MIB loss function is based on a Hilbert-Schmidt Independence Criterion (HSIC).

19. The local computing node of claim 18, wherein updating the parameters of the output layer includes:
computing an output layer gradient; and
stepping the output layer gradient to update the parameters of the output layer.

20. An edge computing node comprising
one or more processors; and
a memory storing instructions which, when executed by the one or more processors cause the one or more processors to carry out operations comprising:
performing computations of a first intermediate layer of at least one intermediate layer of a neural network:
receiving a training request, where the training request is specific to the edge computing node and includes an indication of an input edge computing node and an output edge computing node;
receiving, for a local computing node, an input kernel matrix and an label kernel matrix;
receiving, from the input computing node, an input activation map;
performing computations of the first intermediate layer, on the basis of the input kernel matrix and the label kernel matrix and parameters of the input first intermediate layer, to generate an intermediate layer activation map;
updating the parameters of the first intermediate layer on the basis of a loss computed for the first intermediate layer based on an input activation kernel matrix and the label kernel matrix, the input activation kernel matrix determined based on the input activation map;
transmitting, to the output computing node, the first intermediate layer.
